(19) United States
(12) Patent Application Publication
(10) Pub. No.: US 2023/0128796 A1
(43) Pub. Date: Apr. 27, 2023

(54) CONTROL APPARATUS AND CONTROL METHOD

(71) Applicant: SONY GROUP CORPORATION, Tokyo (JP)

(72) Inventors: Kotoko YAMAGUCHI, Kanagawa (JP); Kazunori YAMAMOTO, Tokyo (JP); Mari IKENAGA, Tokyo (JP)

(73) Assignee: SONY GROUP CORPORATION, Tokyo (JP)

(21) Appl. No.: 17/801,711

(22) PCT Filed: Mar. 22, 2021
(86) PCT No.: PCT/JP2021/011575

§ 371 Date: Aug. 23, 2022

(30) Foreign Application Priority Data
Mar. 30, 2020 (JP) 2020-060598

(51) Int. Cl. B25J 9/16; A47J 36/32; A23L 5/10; B25J 13/00

(52) U.S. Cl. CPC B25J 9/1656; A23L 5/10; A47J 36/32; B25J 13/00; G06Q 50/12

(57) ABSTRACT

There is provided a control apparatus and a control method for enabling a cooking robot to perform cooking efficiently. The control apparatus according to one aspect of the present technology acquires multiple recipe programs each prepared for a dish to be finished by a cooking robot going through multiple cooking processes, thereby creating a cooking process plan on the basis of a resource required for each of the cooking processes. The control apparatus further causes the cooking robot to parallelly execute those of the cooking processes that are parallelly executable for cooking different dishes, on the basis of the cooking process plan. The present technology can be applied to a computer that controls the cooking robot.

### TECHNICAL FIELD

The present technology relates particularly to a control apparatus and a control method for enabling a cooking robot to perform cooking efficiently.

### BACKGROUND ART

Recent years have seen development of cooking robots that cook dishes automatically by driving their robotic arms. Cooking operations using the robotic arms are carried out, for example, by reproducing motions of a chef’s hands. A program for controlling the cooking operations of the cooking robot is prepared for each dish, for example.

### CITATION LIST

### Patent Literature

PTL 1 JP-T-2017-506169
PTL 2 JP-T-2017-536247

### SUMMARY

### Technical Problems

Normally, a dish is finished after undergoing multiple cooking processes such as cutting vegetables, frying the cut vegetables, and serving the fried vegetables. In the case where multiple dishes are to be cooked, for example, it would be inefficient if all cooking processes of a first dish need to be finished before the cooking processes of a second dish can be started.

Depending on the environment in which the cooking robot is installed, there are variations in ingredients and cooking utensils that can be used by the cooking robot for cooking purposes. For example, although the use of an onion is programmed, there may be only a green onion instead of the onion prepared around the cooking robot. In such a case, if it is acceptable to substitute the green onion for the onion in terms of properties such as dish flavor, it is more efficient to continue cooking using the green onion as a substitute ingredient.

The present technology has been devised in view of the above circumstances and enables a cooking robot to perform cooking more efficiently.

### Solution to Problems

According to one aspect of the present technology, there is provided a control apparatus including a cooking process plan creation section configured to acquire multiple recipe programs each prepared for a dish to be finished by a cooking robot going through multiple cooking processes, thereby creating a cooking process plan on the basis of a resource required for each of the cooking processes, and a control section configured to cause the cooking robot to parallelly execute those of the cooking processes that are parallelly executable for cooking different dishes, on the basis of the cooking process plan.

According to another aspect of the present technology, there is provided a control apparatus including an acquisition section configured to acquire multiple recipe programs each prepared for a dish to be finished by a cooking robot going through multiple cooking processes, and a control section configured to execute, in a case where there is prepared a target that falls within an acceptable range for a target stipulated by the recipe program to be used in an operation constituting a cooking process, a program module for the target falling within the acceptable range, thereby causing the cooking robot to execute the operation using the target falling within the acceptable range.

According to one aspect of the present technology, multiple recipe programs each prepared for a dish to be finished by a cooking robot going through multiple cooking processes are acquired. A cooking process plan is created on the basis of a resource required for each of the cooking processes. The cooking robot is caused to parallelly execute those of the cooking processes that are parallelly executable for cooking different dishes, on the basis of the cooking process plan.

According to another aspect of the present technology, multiple recipe programs each prepared for a dish to be finished by a cooking robot going through multiple cooking processes are acquired. In a case where there is prepared a target that falls within an acceptable range for a target stipulated by the recipe program to be used in an operation constituting a cooking process, a program module for the target falling within the acceptable range is executed. The cooking robot is caused to execute the operation using the target falling within the acceptable range.

### BRIEF DESCRIPTION OF DRAWINGS

FIG. 1 is a diagram depicting an exemplary configuration of a cooking system embodying the present technology.

FIG. 2 is a diagram depicting a flow of processes up to completion of a dish.

FIG. 3 is a diagram depicting an exemplary configuration of cooking processes.

FIG. 4 is a diagram depicting an exemplary cooking process execution sequence.

FIG. 5 is a diagram depicting another exemplary cooking process execution sequence.

FIG. 6 is a diagram depicting specific examples of cooking processes.

FIG. 7 is a diagram depicting exemplary resources necessary for different operations.

FIG. 8 is a diagram depicting exemplary constraints on simultaneous execution.

FIG. 9 is a flowchart explaining cooking processes of a cooking robot.

FIG. 10 is a flowchart explaining a cooking process plan creating process performed in step S4 in FIG. 9.

FIG. 11 is a diagram depicting an exemplary timing chart in the case where receipt of an order for dish A is followed by receipt of an order for dish B.

FIG. 12 is a diagram depicting an exemplary timing chart related to creation of a cooking process plan following receipt of the order for dish B.

FIG. 13 is a diagram depicting another exemplary configuration of the cooking system.

FIG. 14 is a diagram depicting specific examples of acceptable ranges for targets to be recognized.

FIG. 15 is a flowchart explaining a cooking process of “finely chopping an onion.”

FIG. 16 is a diagram depicting an exemplary timing chart of operations using results of recognition by an ingredient/cooking utensil recognition service server.

FIG. 17 is a diagram depicting another exemplary timing chart of operations using results of recognition by the ingredient/cooking utensil recognition service server.

FIG. 18 is a block diagram depicting an exemplary functional configuration of the cooking robot.

FIG. 19 is a diagram depicting an exemplary configuration on the side of a restaurant.

FIG. 20 is a diagram depicting exemplary arrangements of a control apparatus.

FIG. 21 is a perspective view depicting an appearance of the cooking robot.

FIG. 22 is an enlarged view of cooking arms.

FIG. 23 is a diagram depicting an appearance of a cooking arm.

FIG. 24 is a diagram depicting exemplary movable ranges of parts of the cooking arm.

FIG. 25 is a diagram depicting exemplary connections between the cooking arms and a controller.

FIG. 26 is a block diagram depicting an exemplary configuration of the cooking robot.

FIG. 27 is a diagram depicting an exemplary device as a control target.

FIG. 28 is a block diagram depicting an exemplary hardware configuration of the ingredient/cooking utensil recognition service server.

FIG. 29 is a block diagram depicting an exemplary functional configuration of the ingredient/cooking utensil recognition service server.

### DESCRIPTION OF EMBODIMENTS

### Overview of the Present Technology

The present technology allows a cooking robot performing cooking processes for preparing dishes to execute in parallel those processes that can be carried out parallelly, thereby enabling efficient cooking. For example, the technology permits parallel execution of the cooking processes for different dishes.

Operations of the cooking robot for preparing dishes are distinguished from each other by cooking process. Each cooking process is constituted by a combination of a recognition operation that recognizes a target and a cooking operation that uses the target by driving cooking arms, for example. A required resource and an approximate time period are defined for each of the operations making up each cooking process. The resources required for each cooking process are thus clearly identified.

On the basis of the resources required for each cooking process, the present technology identifies the cooking processes that can be executed parallelly in creating a cooking process plan. Each cooking process is carried out on the basis of the cooking process plan thus created.

Also, the present technology allows a program module for performing the recognition operation and a program module for carrying out the cooking operation to be acquired from a server at the time the operation of interest is executed. Performing each program module acquired from the server causes the corresponding operation to be carried out.

Acceptable ranges are set for ingredients and cooking utensils constituting the targets for each operation. For example, in the case where an ingredient prepared as a usable target is not the ingredient initially defined by a recipe program but an ingredient that falls within the acceptable range, the program module for the ingredient falling within the acceptable range is acquired from the server, so that the operation targeted for that ingredient falling within the acceptable range will be carried out.

Some embodiments for implementing the present technology are described below. The description will be made in the following order.
1. System configuration
2. First embodiment (parallel execution of cooking processes)
3. Second embodiment (acceptable ranges for targets used for cooking)
4. Configurations of apparatuses
5. Others

### System Configuration

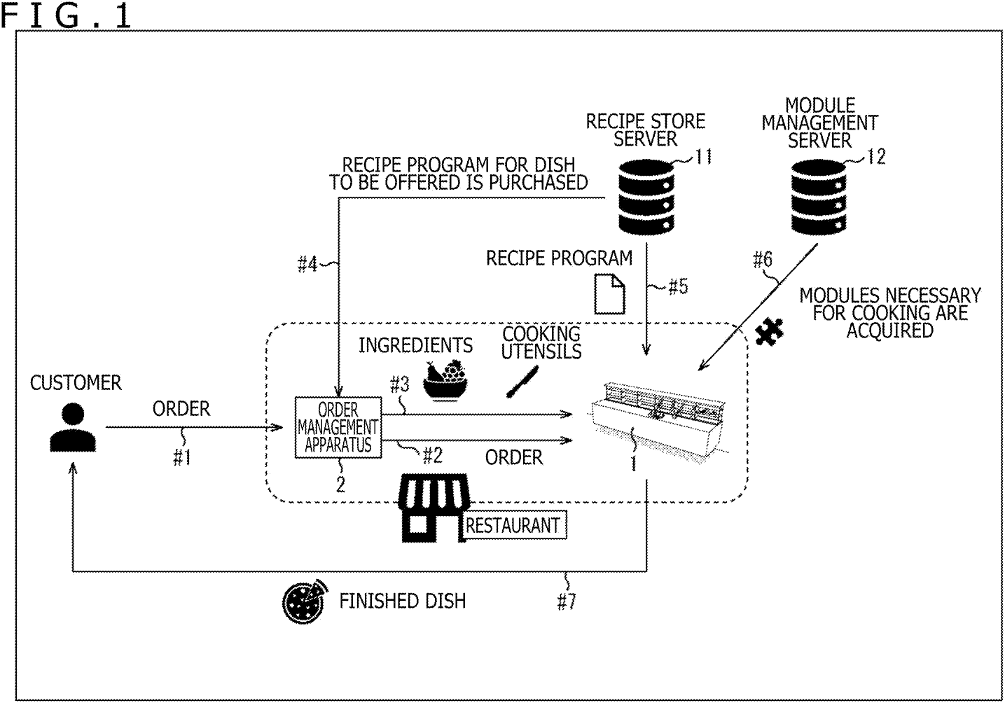

FIG. 1 is a diagram depicting an exemplary configuration of a cooking system embodying the present technology.

The cooking system in FIG. 1 includes a cooking robot 1, an order management apparatus 2, a recipe store server 11, and a module management server 12. The apparatuses are interconnected via a network such as the Internet or a LAN (Local Area Network). At least the communication between the cooking robot 1 and the recipe store server 11 and the communication between the cooking robot 1 and the module management server 12 are carried out via the Internet.

The cooking robot 1 and the order management apparatus 2 are installed in a restaurant as indicated enclosed in a broken-line frame. The cooking robot 1 and the order management apparatus 2 may alternatively be installed in locations other than restaurants where cooking is performed, such as in households or food factories. While only one cooking robot 1 is depicted in FIG. 1, multiple cooking robots 1 installed in different locations are each connected to the recipe store server 11 and to the module management server 12.

The cooking robot 1 is a robot that has cooking functions implemented by driven devices such as cooking arms as well as various sensors. Recipe programs control the cooking robot 1 during cooking.

The recipe programs are designed to control the cooking performed by the cooking robot 1. A recipe program is prepared for each of the dishes to be cooked by the cooking robot 1. Executing the recipe programs allows the cooking robot 1 to perform cooking.

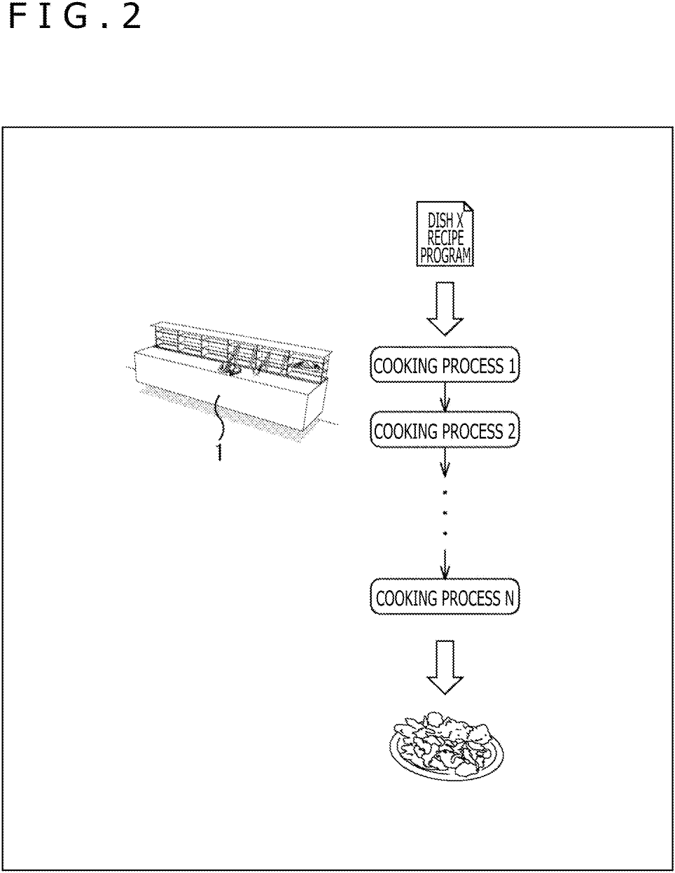

For example, as depicted in FIG. 2, one dish is finished when the operations of all cooking processes based on one recipe program are completed. In the example in FIG. 2, the operations of cooking processes 1 through N are carried out. Each of the cooking processes constitutes a unit of cooking such as “cut vegetables,” “fry vegetables,” or “serve vegetables.” One cooking process includes at least one operation of processing one target ingredient using a predetermined cooking utensil, for example.

Incidentally, a dish means a product having undergone cooking. Cooking signifies the processing or the act (work) of preparing dishes. The ingredients include plant-based ingredients such as vegetables and fruits, animal source ingredients such as meat and fish, processed ingredients, condiments, and beverages such as water and liquor.

With the cooking system in FIG. 1, in the case where an order from a customer in the restaurant is received by the order management apparatus 2 as indicated by arrow #1, information regarding the ordered dish is output to the cooking robot 1 as indicated by arrow #2.

The order management apparatus 2 is a computer operated by an administrator of the restaurant. In the case where an order is placed by a customer, the administrator operates the order management apparatus 2 to input information regarding the ordered dish to the cooking robot 1. The administrator prepares the ingredients and cooking utensils as needed for use by the cooking robot 1, as indicated by arrow #3.

The order management apparatus 2 is also used to purchase a recipe program for a dish to be served in the restaurant, as indicated by arrow #4. For example, the administrator of the order management apparatus 2 operates the order management apparatus 2 to access a recipe store, which is a website managed by the recipe store server 11, to purchase beforehand the recipe programs for the dishes to be served in the restaurant.

When a procedure for purchasing a recipe program is executed, the recipe program can be acquired from the recipe store server 11. The purchased recipe program is supplied as indicated by arrow #5 when, for example, an order is placed for a dish and the recipe program for the dish is requested from the cooking robot 1.

The recipe program supplied to the cooking robot 1 is executed by the cooking robot 1. This allows the cooking robot 1 to start operations to cook the ordered dish. In this manner, the recipe store server 11 manages the recipe store website and functions as a server that supplies the cooking robot 1 with the recipe programs for diverse dishes as needed.

The recipe program supplied from the recipe store server 11 describes information regarding all cooking processes for completing the dish as discussed above. The cooking robot 1 performs the operations of all cooking processes based on the recipe program so as to finish the ordered dish.

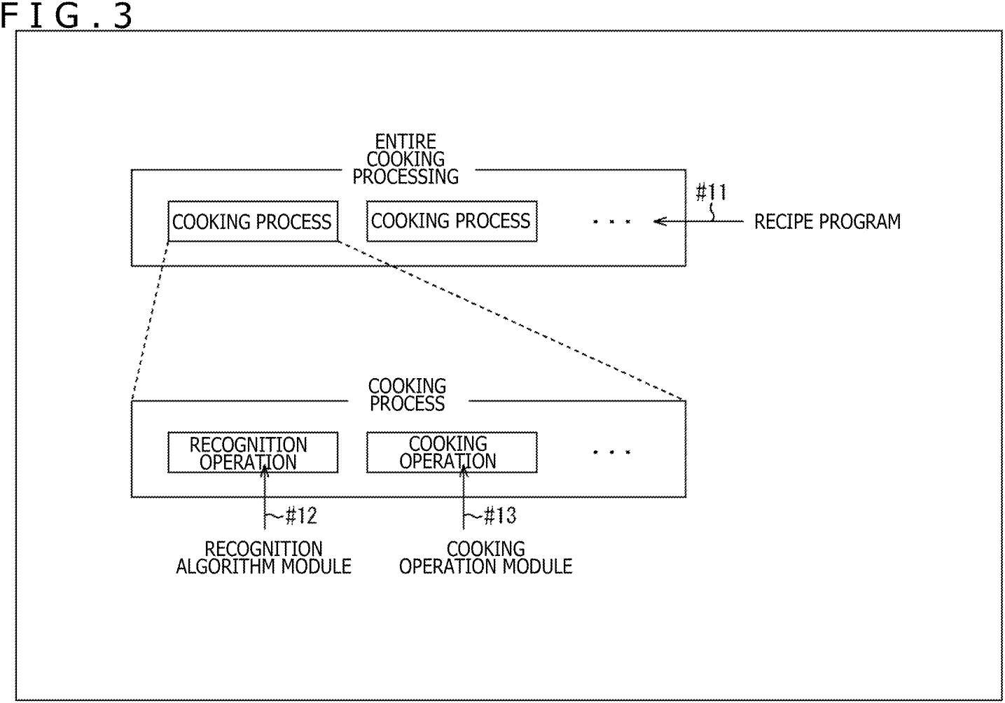

FIG. 3 is a diagram depicting an exemplary configuration of cooking processes.

As depicted in an upper part of FIG. 3, entire cooking processing for completing one dish includes multiple cooking processes. As indicated by arrow #11, the whole cooking processing is implemented on the basis of one recipe program.

As indicated in a lower part of FIG. 3, one cooking process includes one or multiple recognition operations and one or multiple cooking operations. One cooking process may include solely recognition operations or include only cooking operations.

The recognition operation is an operation that recognizes targets for use in cooking operations, such as ingredients and cooking utensils. The cooking operation is an operation that drives the configured components such as cooking arms to perform cooking by use of the targets recognized by the recognition operation.

One recognition operation is carried out by executing one recognition algorithm module as indicated by arrow #12. One cooking operation is performed by executing one cooking operation module as indicated by arrow #13.

That is, the operations included in a cooking process are a series of operations being divided into multiple operations (recognition and cooking operations). Each of the operations is implemented by a different module (program module) prepared for the corresponding operation.

Returning to the explanation of FIG. 1, the cooking robot 1, while doing cooking based on the recipe program, repeatedly accesses the module management server 12 to acquire therefrom modules necessary for operations at different times as indicated by arrow #6. The cooking robot 1 performs the operations at various times by executing the modules obtained from the module management server 12.

As discussed above, the recipe program used by the cooking system in FIG. 1 does not include modules for executing operations at different times. The module for performing the operation at a given time is acquired as needed from the module management server 12.

Alternatively, the modules for carrying out the operations at various times may be packaged along with the recipe program, so that a package including the recipe program and the modules may be supplied to the cooking robot 1.

The module management server 12 functions as a server that supplies the cooking robot 1 with the modules requested by the latter, the cooking robot 1 executing the supplied modules. The module management server 12 manages the recognition algorithm modules for recognizing diverse targets as well as the cooking operation modules. For example, the module management server 12 is managed by the same business operator that manages the recipe store server 11.

The dish finished by the operations of all cooking processes having been carried out using the modules acquired from the module management server 12 is served to the customer in the restaurant as indicated by arrow #7.

### First Embodiment: Parallel Execution of Cooking Processes

### Overview of Parallel Execution

One dish is finished after undergoing multiple cooking processes performed by the cooking robot 1. For example, in the case where multiple dishes are cooked by one cooking robot 1, some of the processes of cooking the dishes can be performed parallelly. It is then more efficient if the parallelly executable cooking processes are carried out in parallel with each other.

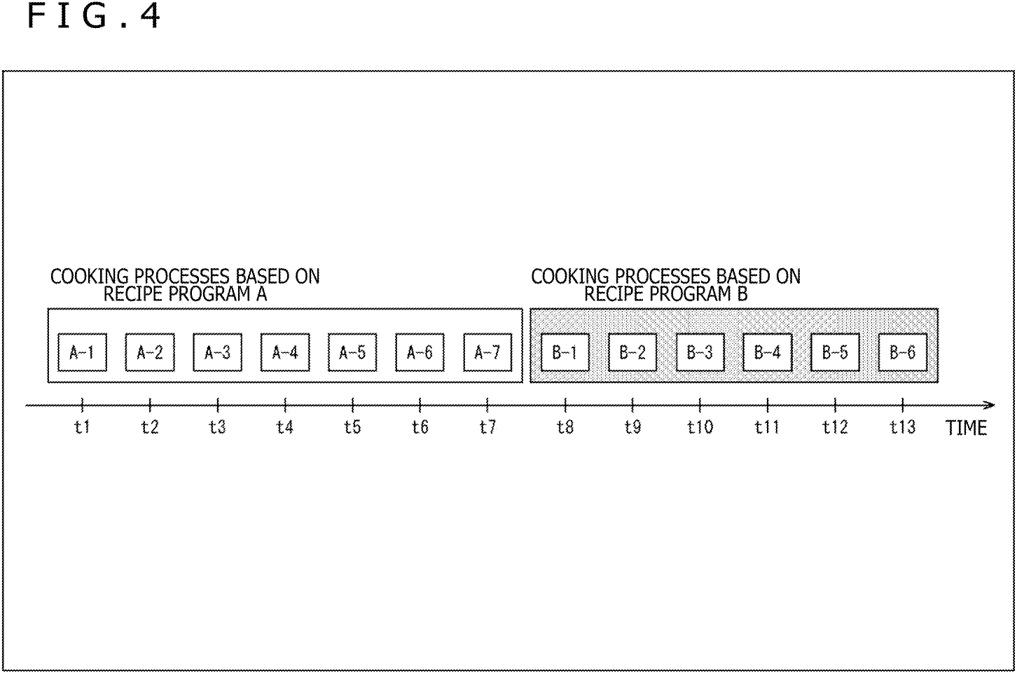

FIG. 4 is a diagram depicting an exemplary cooking process execution sequence.

Cooking processes A-1 through A-7 depicted on a left side in FIG. 4 are performed on the basis of a recipe program A, which is the recipe program for a dish A. Executing the recipe program A causes operations of the cooking processes A-1 through A-7 to be carried out in sequence.

Meanwhile, cooking processes B-1 through B-6 depicted shaded on a right side in FIG. 4 are performed on the basis of a recipe program B, which is the recipe program for a dish B. Executing the recipe program B causes operations of the cooking processes B-1 through B-6 to be carried out sequentially.

For example, suppose that an order for the dish A is first received and, after the cooking processes for the dish A are started, an order for the dish B is received. In such a case, if no cooking processes are performed parallelly, the dish A is first finished after undergoing the cooking processes A-1 through A-7, before the cooking processes for the dish B are started as depicted in FIG. 4. In the example in FIG. 4, the cooking processes A-1 through A-7 are carried out at times t1 through t7, respectively, and at time t8 after the dish A has been finished, the cooking processes for the dish B are started. The cooking processes B-1 through B-6 are then performed at times t8 through t13, respectively, which completes the dish B.

Incidentally, while it is assumed in FIG. 4 that it takes the same amount of time period for each cooking process to be carried out, different cooking processes require different amounts of time period in practice.

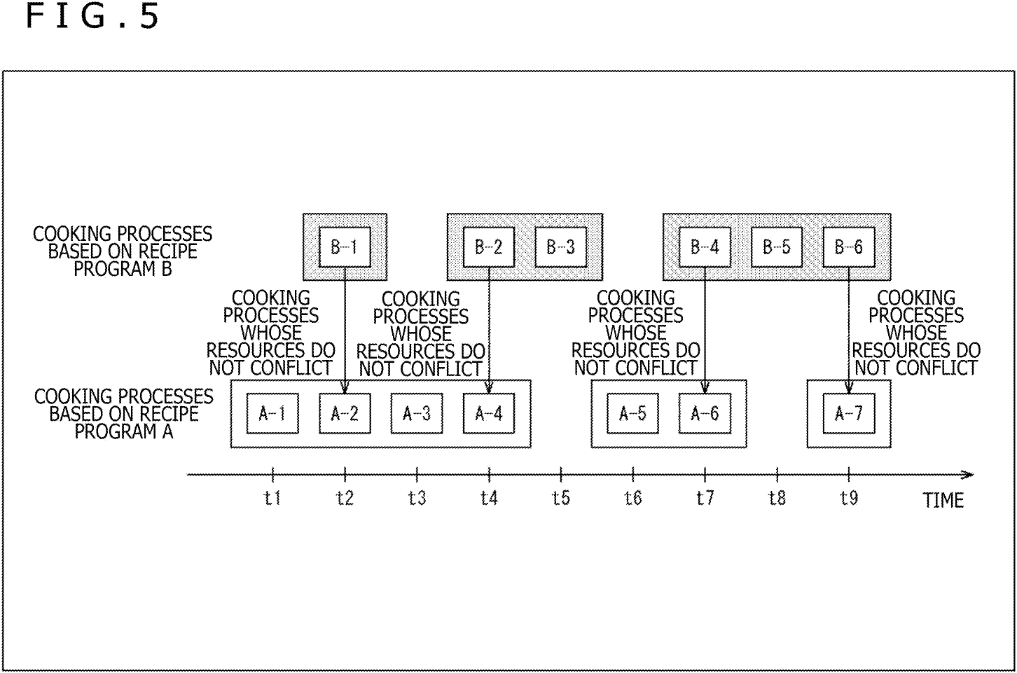

FIG. 5 is a diagram depicting another exemplary cooking process execution sequence.

The cooking processes depicted in a lower part of FIG. 5 are performed on the basis of the recipe program A. The cooking processes found in an upper part of FIG. 5 are carried out on the basis of the recipe program B.

The cooking robot 1 creates a cooking process plan that describes an execution sequence of cooking processes, and carries out these cooking processes in accordance with the cooking process plan thus created. The cooking process plan is created when, for example, with the cooking processes for a given dish already started, an order for another dish is received.

In creating the cooking process plan, the resources necessary for executing each cooking process are referenced, so that parallelly executable cooking processes are specified. In the example in FIG. 5, the cooking process A-1 is performed at time t1, followed by the cooking processes A-2 and B-1 carried out in parallel at time t2. As indicated connected by an arrow, the cooking processes A-2 and B-1 do not conflict with each other in terms of resources.

In like manner, those of subsequent cooking processes that do not conflict with one another in terms of resources are carried out in parallel. In the example in FIG. 5, the cooking processes A-4 and B-2 are performed in parallel at time t4, and the cooking processes A-6 and B-4 are executed parallelly at time t7. Then at time t9, the cooking processes A-7 and B-6 are carried out in parallel, which completes the dishes A and B.

In this manner, of the cooking processes based on multiple recipe programs, those that can be performed parallelly are carried out in parallel as needed. This enables the cooking robot 1 to efficiently perform cooking in preparing multiple dishes. Also, the cooking robot 1 can rapidly cook dishes and quickly serve them to customers.

For the purpose of explanation, in FIG. 5, the unit of the parallelly executable cooking processes is assumed to be a cooking process. Alternatively, the operations included in each cooking process may each be regarded as the unit, so that parallelly executable operations may be specified in units of operations and executed in parallel as needed.

### Cooking Process Plan

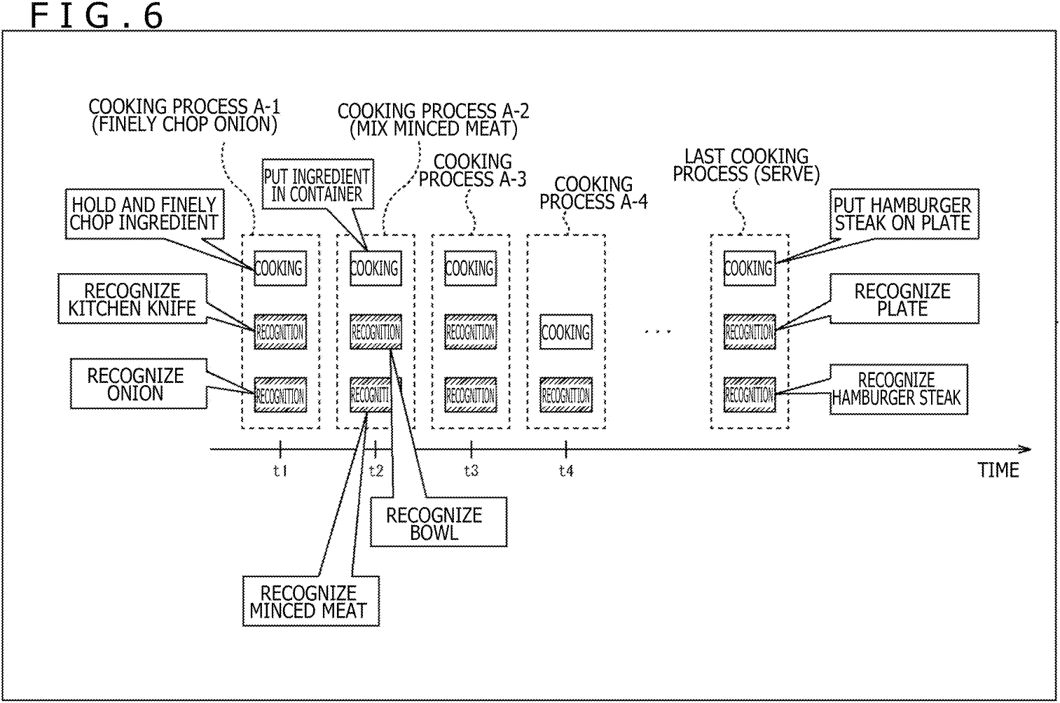

FIG. 6 is a diagram depicting specific examples of cooking processes.

The cooking processes enclosed by broken lines in FIG. 6 are based on a recipe program “hamburger steak.” The cooking process A-1, the cooking process A-2, the cooking process A-3, the cooking process A-4, ... and the last cooking process are carried out in accordance with the recipe program, which completes the dish “hamburger steak.” The cooking process A-1 is a process of “finely chopping an onion,” and the cooking process A-2 is a process of “mixing minced meat.” The last cooking process is a process of “serving.”

The operations of each cooking process include recognition and cooking operations. In FIG. 6, a rectangle enclosing the word “recognition” denotes a recognition operation, and a rectangle enclosing the word “cooking” represents a cooking operation.

As indicated by balloons in FIG. 6, the cooking process A-1 of “finely chopping an onion” includes a cooking operation of “holding and finely chopping the ingredient,” and recognition operations of “recognizing a kitchen knife” and “recognizing an onion.” The cooking process A-1 thus involves the operations of recognizing the kitchen knife and the onion, of holding the recognized onion with a cooking arm, of holding the recognized kitchen knife with another cooking arm, and of finely chopping the onion with the kitchen knife.

Likewise, the cooking process A-2 of “mixing minced meat” includes a cooking operation of “putting the ingredient in a container,” and recognition operations of “recognizing a bowl” and “recognizing minced meat.” The cooking process A-2 thus involves the operations of recognizing the bowl and minced meat, of holding the recognized minced meat with a cooking arm, and of putting the minced meat into the bowl.

Although not depicted, the cooking processes found in FIG. 6 include more cooking and recognition operations. In this manner, each cooking process includes a combination of cooking and recognition operations.

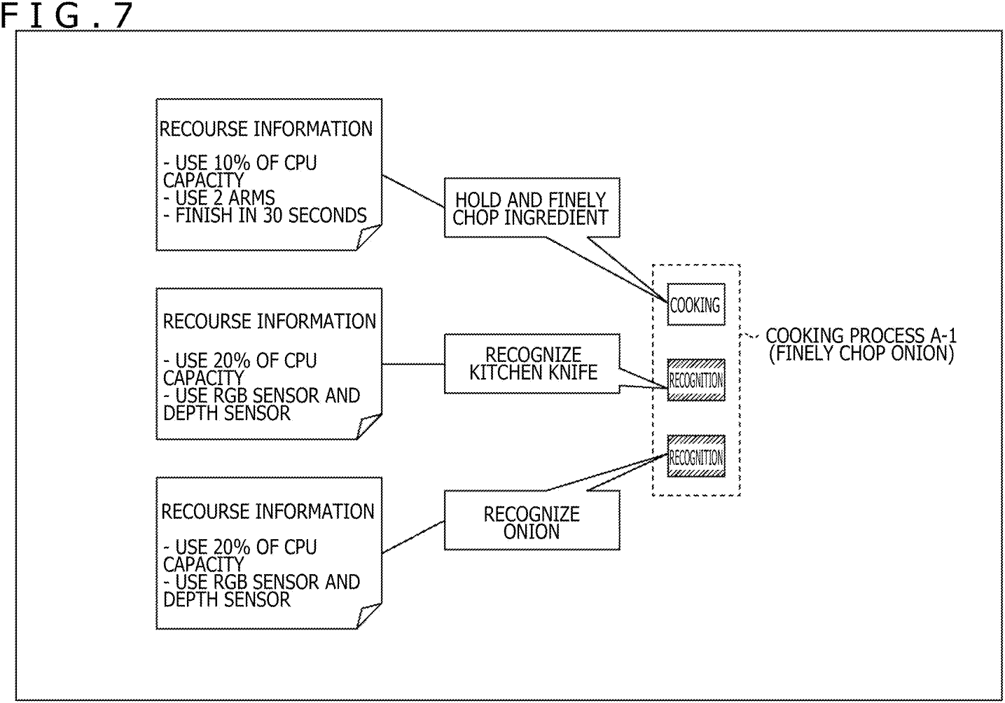

FIG. 7 is a diagram depicting exemplary resources necessary for different operations.

The recognition and cooking operations constituting each cooking process are associated with resource information. The resource information relates to the resources required in the case where the associated operation is to be carried out. The resource information is included in the recipe programs, for example.

FIG. 7 depicts the resource information associated with a cooking operation of “holding and finely chopping the ingredient” and with recognition operations of “recognizing a kitchen knife” and “recognizing an onion,” the cooking and recognition operations making up the cooking process A-1 of “finely chopping an onion.”

For example, the cooking operation of “holding and finely chopping the ingredient” requires the resources of using 10% of CPU capacity and of employing two cooking arms. Taking up 10% of CPU capacity signifies an occupancy rate of 10% of computing power of the CPU acting as a calculation section of the cooking robot 1. The resource information also indicates that the cooking operation of “holding and finely chopping the ingredient” is an operation that is finished in 30 seconds.

As described above, the resource information includes information regarding the occupancy rate of the computing power of the calculation section controlling the cooking robot 1, information regarding a hardware configuration of the cooking robot 1, and information indicating the time period required for the operations. At least any one of these three types of information may be included in the resource information.

Further, the recognition operations of “recognizing a kitchen knife” and “recognizing an onion” are each an operation that requires the resources of taking up 20% of CPU capacity and of using an RGB sensor and a depth sensor.

For example, the resources for the recognition operations are defined by developers of recognition algorithm modules at the time of development, the defined resources being associated with the recognition operations. Also, the resources for the cooking operations are defined by developers of cooking operation modules at the time of development, the defined resources being associated with the cooking operations.

At the time the cooking process plan is created, those of the cooking processes that are parallelly executable are specified on the basis of the resources for these operations and of constraints on simultaneous execution. The simultaneous execution constraints represent constraints on the simultaneously (parallelly) executable cooking processes and are established according to the hardware configuration of the cooking robot 1 and the environment in which the cooking robot 1 is installed.

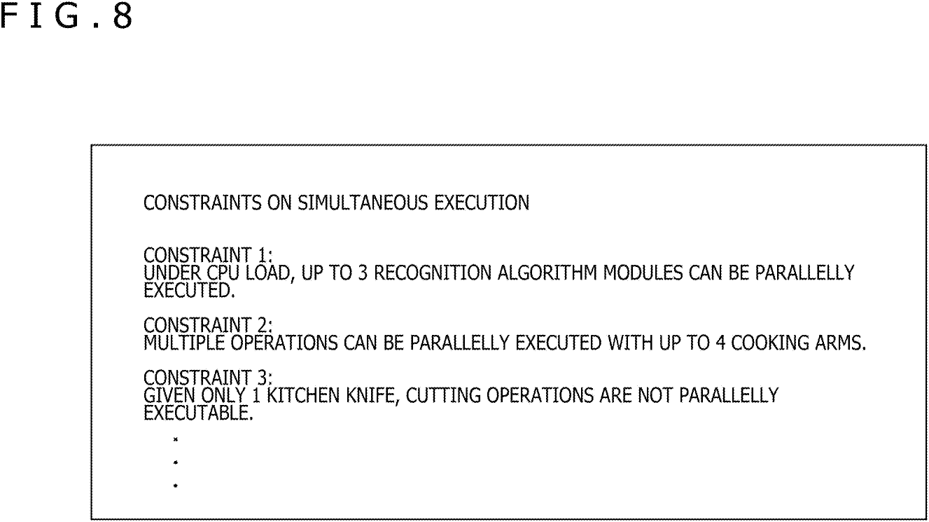

FIG. 8 is a diagram depicting exemplary constraints on simultaneous execution.

Constraint 1 in FIG. 8 specifies that up to three recognition algorithm modules are parallelly executable in view of the load on the CPU. Constraint 2 specifies that multiple cooking operations are parallelly executable provided they can be performed with up to four cooking arms. Constraint 3 specifies that, with only one kitchen knife available, chopping operations are not parallelly executable.

The constraints 1 and 2 are set according to the hardware configuration of the cooking robot 1. The constraint 3 is established depending on the environment in which the cooking robot 1 is installed. The environment where the cooking robot 1 is set up includes status of ingredients usable by the cooking robot 1 and status of cooking utensils.

With regard to the constraint 1, for example, the cooking process A-1 of “finely chopping an onion” in FIG. 7 includes two recognition operations of “recognizing a kitchen knife” and “recognizing an onion.” That means a cooking process including only one recognition operation can be executed in parallel with the cooking process A-1.

Further, with respect to the constraint 2, the cooking operation of “holding and finely chopping the ingredient” included in the cooking process A-1 requires as the resource that two cooking arms be used. That means a cooking process including a cooking operation of using only two cooking arms can be executed in parallel with the cooking process A-1.

With regard to the constraint 3, the cooking operation of “holding and finely chopping the ingredient” included in the cooking process A-1 involves chopping the ingredient. That means a cooking process not including the operation of chopping the ingredient can be executed in parallel with the cooking process A-1.

In practice, a cooking process satisfying all the constraints 1 through 3 is executable in parallel with the cooking process A-1. The resources required for the cooking process A-1 are the sum of the resources required for the cooking operation of “holding and finely chopping the ingredient” and the resources required for the recognition operations of “recognizing a kitchen knife” and “recognizing an onion.”

Whether or not a given cooking process (first cooking process) can be executed in parallel with another cooking process (second cooking process) is determined on the basis of whether or not the resources totaling those required for the first and second cooking processes satisfy the simultaneous execution constraints. In the case where the simultaneous execution constraints are satisfied, the first and second cooking processes are specified as parallelly executable cooking processes.

The parallelly executable cooking processes may also be specified in consideration of execution time periods. For example, when the cooking operation of “holding and finely chopping the ingredient” is finished in 30 seconds, a cooking process that can be finished within 30 seconds is executable in parallel with the cooking process A-1.

As described above, the resources and approximate execution time periods are defined for each of the recognition and cooking operations included in each cooking process. That means the resources and execution time period required for each cooking process are also clearly specified. The cooking robot 1 can create the cooking process plan by specifying the parallelly executable cooking processes on the basis of the defined information.

### Operations of the Cooking Robot

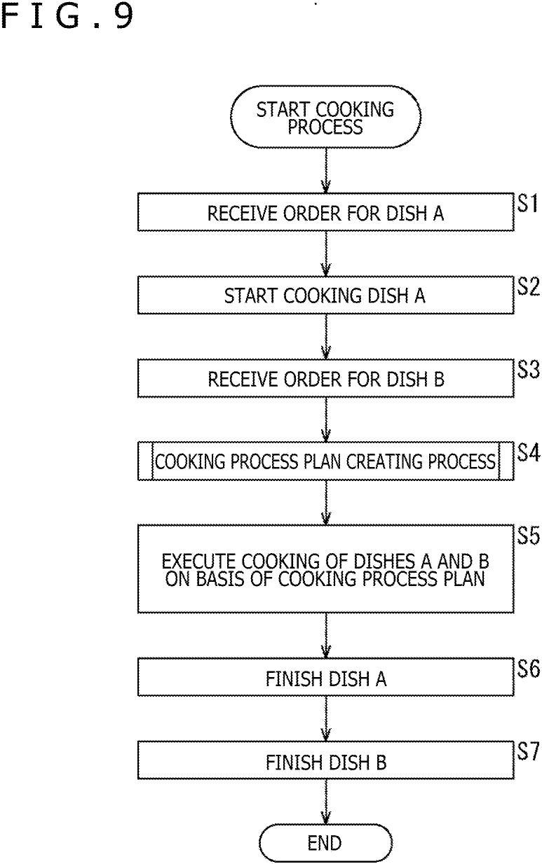

Explained below with reference to the flowchart of FIG. 9 are the cooking processes of the cooking robot 1. The processes in FIG. 9 are started when, for example, an order for a dish A is received by the order management apparatus 2.

In step S1, the cooking robot 1 receives an order for the dish A input from the order management apparatus 2. The cooking robot 1 acquires the recipe program for the dish A from the recipe store server 11.

In step S2, the cooking robot 1 starts cooking the dish A on the basis of the recipe program acquired from the recipe store server 11.

In the case where an order for a dish B is received by the order management apparatus 2 subsequent to the dish A, step S3 is reached. In step S3, the cooking robot 1 receives the order for the dish B input from the order management apparatus 2. The cooking robot 1 acquires the recipe program for the dish B from the recipe store server 11.

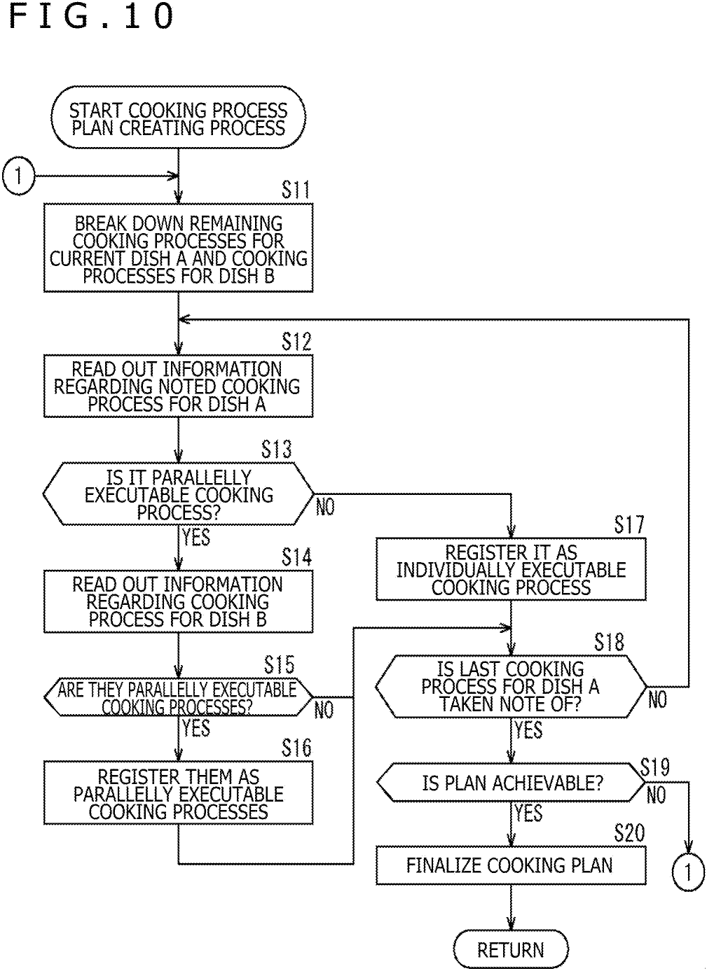

In step S4, the cooking robot 1 performs a cooking process plan creating process. The cooking process plan creating process is a process of creating a cooking process plan. The cooking process plan creating process will be discussed later with reference to the flowchart of FIG. 10.

In step S5, the cooking robot 1 cooks the dish A and the dish B on the basis of the cooking process plan. Where any one of the cooking processes for the dishes A and B is registered as a parallelly executable process in the cooking process plan, that process may be carried out in parallel as needed.

When the entire cooking processing for the dish A is completed, the cooking robot 1 finishes the dish A in step S6.

Further, when the entire cooking processing for the dish B is completed, the cooking robot 1 finishes the dish B in step S7. The cooking process plan may be created in such a manner that the dish A, which is ordered first, is finished first.

Explained next with reference to the flowchart of FIG. 10 is the cooking process plan creating process performed in step S4 in FIG. 9.

In step S11, the cooking robot 1 breaks down the remaining cooking processes for the dish A and the cooking processes for the dish B into the recognition and cooking operations included in each cooking process, on the basis of the recipe program for the dish A and the recipe program for the dish B.

In step S12, the cooking robot 1 takes note of the first of the remaining cooking processes for the dish A, and reads out information regarding the noted cooking process. Here, for example, the resource information regarding each of the operations included in the noted cooking process is read out. As explained above with reference to FIG. 7, the resource information is associated with the recognition and cooking operations included in each cooking process.

In step S13, the cooking robot 1 determines whether or not the noted cooking process for the dish A is set as a cooking process parallelly executable with another cooking process.

For example, each cooking process is set with information indicating whether or not the process is executable in parallel with another cooking process. The determination in step S13 is made on the basis of this information set in each cooking process.

For example, a cooking process with its operations required to be performed sequentially is set with information indicating that the process is not executable in parallel with any other cooking process. A cooking process with its operations having a prolonged idle time period therebetween is set with information indicating that the process is executable with another cooking process.

In the case where it is determined in step S13 that the noted cooking process for the dish A is set as a cooking process executable in parallel with another cooking process, control is transferred to step S14.

In step S14, the cooking robot 1 takes note of the first of the cooking processes for the dish B, and reads out the information regarding the noted cooking process. For example, the resource information regarding each of the operations included in the noted cooking process for the dish B is read out.

In step S15, the cooking robot 1 determines whether or not the noted cooking process for the dish A and the noted cooking process for the dish B are parallelly executable.

Here, a total sum is obtained of the resources for the operations included in the noted cooking process for the dish A and of the resources for the operations included in the noted cooking process for the dish B, the total sum being compared with the simultaneous execution constraints. In the case where the resources totaling those for the two cooking processes satisfy the simultaneous execution constraints, it is determined that the noted cooking process for the dish A and the noted cooking process for the dish B are parallelly executable.

In the case where it is determined in step S15 that the noted cooking process for the dish A and the noted cooking process for the dish B are parallelly executable, control is transferred to step S16.

In step S16, the cooking robot 1 registers the noted cooking process for the dish A and the noted cooking process for the dish B as parallelly executable cooking processes.

On the other hand, in the case where it is determined in step S13 that the noted cooking process for the dish A is not set as a cooking process executable in parallel with another cooking process, step S17 is reached. In step S17, the cooking robot 1 registers the noted cooking process for the dish A as an individually executable cooking process.

After the cooking process for the dish A is registered in step S17 as an individually executable cooking process, control is transferred to step S18. Step S18 is reached likewise in the case where it is determined in step S15 that the cooking process for the dish A and the cooking process for the dish B are not parallelly executable or in the case where the cooking process for the dish A and the cooking process for the dish B are registered as parallelly executable cooking processes in step S16.

In step S18, the cooking robot 1 determines whether or not the last cooking process for the dish A is taken note of. In the case where it is determined in step S18 that the last cooking process for the dish A is not taken note of, control is returned to step S12. In step S12, the next cooking process for the dish A is taken note of. The subsequent steps are then repeated.

In the case where it is determined in step S18 that the last cooking process for the dish A is taken note of, step S19 is reached. In step S19, the cooking robot 1 determines whether or not the cooking process plan including the cooking processes registered as described above is an achievable plan.

For example, a cooking process plan in which the dish A is finished before the dish B is determined to be an achievable plan. Also, a cooking process plain in which the dish A and the dish B are each finished within a predetermined time period is determined to be an achievable plan.

In the case where it is determined in step S19 that the cooking process plan is not achievable, control is returned to step S11. The subsequent steps are then repeated in keeping with the current cooking process for the dish A.

In the case where it is determined in step S19 that the cooking process plan is an achievable plan, step S20 is reached. In step S20, the cooking robot 1 finalizes the cooking process plan. Thereafter, control is returned to step S4 in FIG. 9, and the subsequent steps are repeated.

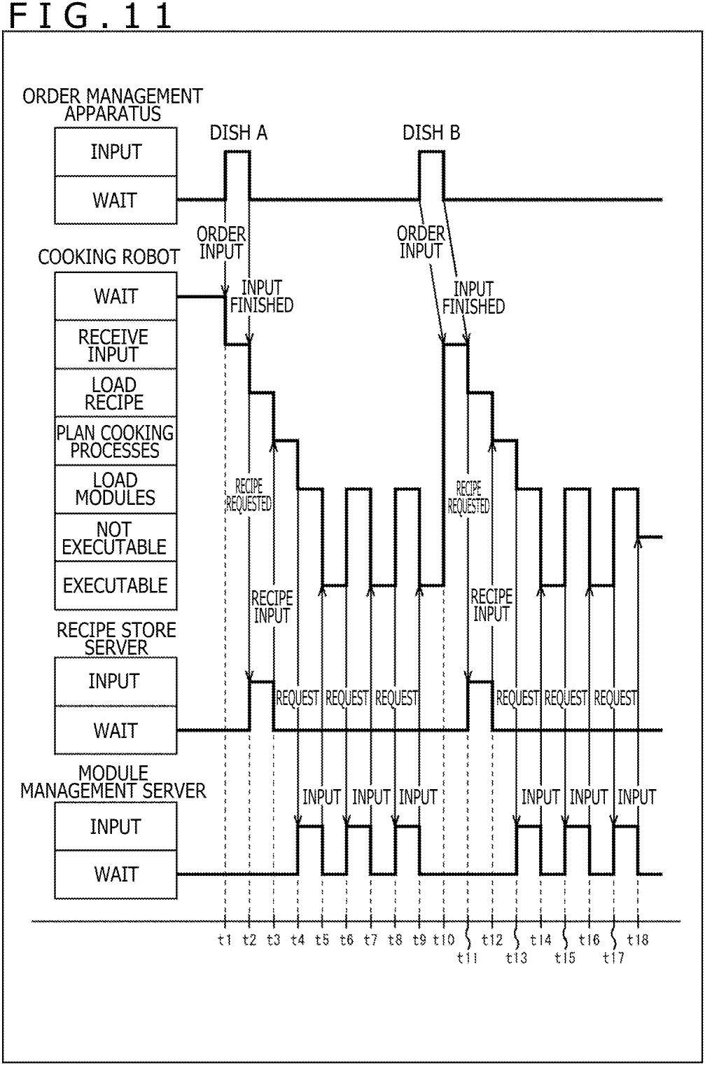

FIG. 11 is a diagram depicting an exemplary timing chart in the case where receipt of an order for the dish A is followed by receipt of an order for the dish B.

In FIG. 11, a horizontal axis denotes time, and a vertical axis represents the state of each apparatus. In order from the top, FIG. 11 indicates the states of the order management apparatus 2, the cooking robot 1, the recipe store server 11, and the module management server 12.

### Time t1

The order management apparatus 2 inputs the order for the dish A to the cooking robot 1.

The cooking robot 1 receives input of the order for the dish A.

### Time t2

Upon receipt of the order for the dish A, the cooking robot 1 accesses the recipe store server 11 and requests transmission of the recipe program for the dish A.

### Time t3

In response to the request from the cooking robot 1, the recipe store server 11 transmits the recipe program for the dish A to the cooking robot 1.

The cooking robot 1 receives the recipe program and creates a cooking process plan accordingly. In this state, the dish for which the order has been received is only the dish A, and thus, a cooking process plan is created in a manner sequentially executing the cooking processes for the dish A in accordance with the recipe program for the dish A.

### Time t4

The cooking robot 1 requests the modules necessary for the operations in the cooking processes from the module management server 12.

### Time t5

In response to the request from the cooking robot 1, the module management server 12 transmits the modules.

The cooking robot 1 receives and executes the modules sent from the module management server 12. Executing the modules allows the cooking robot 1 to perform predetermined recognition or cooking operations.

### Time t6 to Time t9

The cooking robot 1 executes the modules repeatedly.

As indicated in an upper part of FIG. 11, the order management apparatus 2 inputs an order for the dish B to the cooking robot 1.

### Time t10

The cooking robot 1 receives input of the order for the dish B.

### Time t11

Upon receipt of the order for the dish B, the cooking robot 1 accesses the recipe store server 11 and requests transmission of the recipe program for the dish B.

### Time t12

In response to the request from the cooking robot 1, the recipe store server 11 transmits the recipe program for the dish B to the cooking robot 1.

The cooking robot 1 receives the recipe program and creates a cooking process plan accordingly. In this state, the dishes for which the orders have been received are the dishes A and B, and thus, the cooking process plan is created in such a manner that parallelly executable cooking processes are to be executed in parallel, on the basis of the recipe program for the dish A and the recipe program for the dish B.

Thereafter, the cooking processes for the dish A and those for the dish B are carried out in accordance with the created cooking process plan.

### Time t13

The cooking robot 1 requests the modules necessary for the operations in the ongoing cooking process from the module management server 12. In the case where the cooking processes for the dishes A and B are parallelly executed, the modules needed for the operations in the cooking processes for the dishes A and B are requested.

### Time t14

In response to the request from the cooking robot 1, the module management server 12 transmits the modules.

The cooking robot 1 receives and executes the modules sent from the module management server 12. Executing the modules enables the cooking robot 1 to perform predetermined recognition or cooking operations.

### Time t15 to time 18

The cooking robot 1 repeatedly executes the modules.

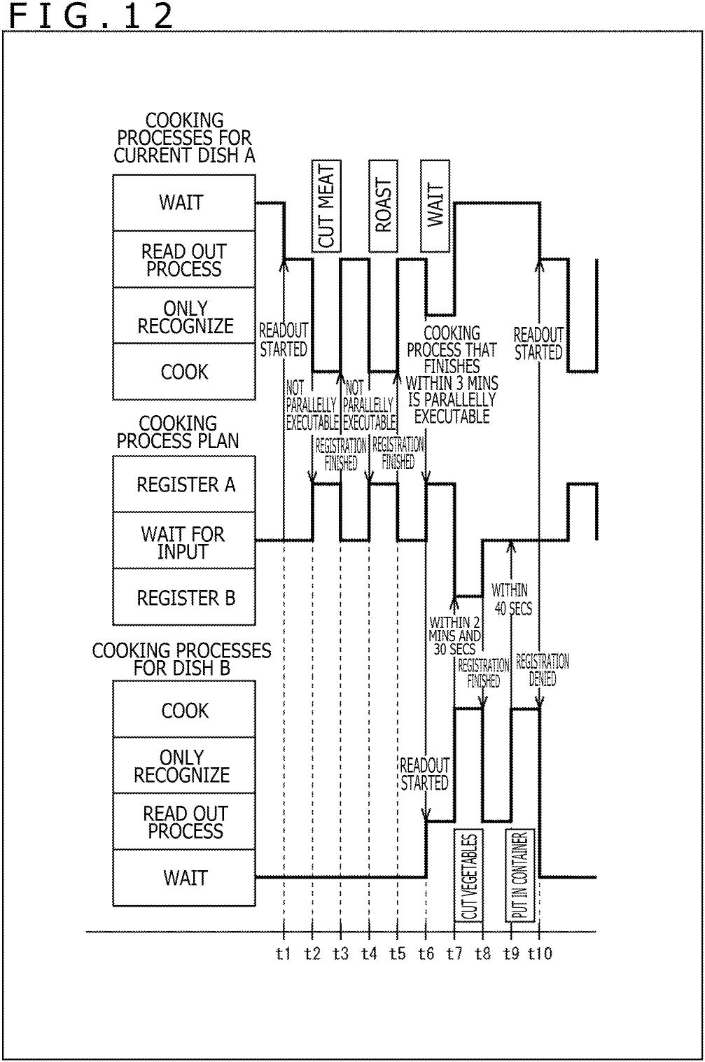

FIG. 12 is a diagram depicting an exemplary timing chart related to creation of the cooking process plan following receipt of the order for the dish B.

The processes depicted in FIG. 12 are carried out at time t12 to time t13 in FIG. 11. An upper part of FIG. 12 indicates how the information regarding the ongoing cooking processes for the dish A is handled, and a middle part indicates the state in which the cooking process plan is being created. A lower part indicates how the information regarding the cooking processes for the dish B is handled.

### Time t1

The cooking robot 1 starts reading out the ongoing cooking processes for the dish A. For example, the remaining cooking processes for the dish A are read out sequentially starting from the first process and are each set as the noted cooking process.

### Time t2

The cooking robot 1 verifies that a cooking process of “cutting meat” as the noted cooking process for the dish A is set as a cooking process not executable in parallel with any other cooking process. As described above, each cooking process is set with the information indicating whether or not the process can be executed in parallel with another cooking process.

### Time t3

The cooking robot 1 registers the cooking process of “cutting meat” for the dish A as an individually executable cooking process. The cooking robot 1 then takes note of a cooking process of “roasting” next to the cooking process of “cutting meat.”

### Time t4

The cooking robot 1 verifies that the noted cooking process of “roasting” for the dish A is set as a cooking process not executable in parallel with any other cooking process.

### Time t5

The cooking robot 1 registers the cooking process of “roasting” for the dish A as an individually executable cooking process. The cooking robot 1 then takes note of a cooking process of “waiting” next to the cooking process of “roasting.”

### Time t6

The cooking robot 1 verifies that the cooking process of “waiting” as the noted cooking process for the dish A is set as a cooking process executable in parallel with another cooking process that can be finished within three minutes. Further, the cooking robot 1 starts reading out the cooking processes for the dish B. For example, the cooking processes for the dish B are read out sequentially starting from the first process and are each set as the noted cooking process.

### Time t7

The cooking robot 1 verifies that a cooking process of “cutting vegetables” as the noted cooking process for the dish B is a cooking process that is finished within two minutes and 30 seconds.

### Time t8

Because the cooking process of “cutting vegetables” as the noted cooking process is finished in less than three minutes, the cooking robot 1 registers this cooking process as a cooking process to be executed in parallel with the cooking process of “waiting” for the dish A. The cooking robot 1 then takes note of a cooking process of “putting in a container” next to the cooking process of “cutting vegetables” for the dish B.

### Time t9

The cooking robot 1 verifies that the cooking process of “putting in a container” as the noted cooking process for the dish B is a cooking process that is finished within 40 seconds.

### Time t10

Because the cooking process of “putting in a container” as the noted cooking process for the dish B cannot be finished within three minutes subsequent to the cooking process of “cutting vegetables,” the cooking robot 1 does not register the cooking process of “putting in a container” as a cooking process executable in parallel with the cooking process of “waiting” for the dish A.

Thereafter, the noted cooking processes for the dishes A and B are changed and executed repeatedly in a like manner.

By carrying out the operations of the respective cooking processes in accordance with the cooking process plan created as described above, the cooking robot 1 can efficiently cook the dishes A and B.

Explained above is the case in which two dishes are cooked. In the case where three or more dishes are to be cooked, a cooking process plan is created likewise on the basis of the recipe programs for the respective dishes. The cooking processes for the multiple dishes are carried out in parallel with each other where appropriate.

Explained above is also the case in which different dishes are cooked. Alternatively, multiple cooking processes may be executed in parallel with each other to make one dish.

As another alternative, parallelly executable multiple cooking processes may be performed not by one cooking robot but by multiple cooking robots in a shared manner.

### Second Embodiment (Acceptable Ranges for Targets Used for Cooking)

### System Configuration

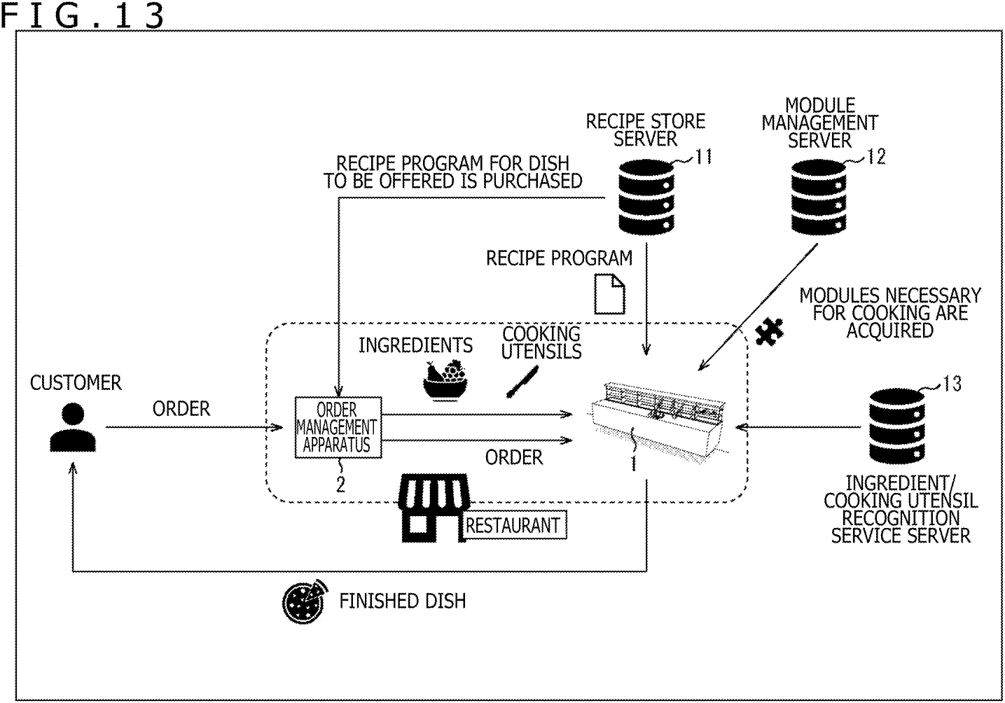

FIG. 13 is a diagram depicting another exemplary configuration of the cooking system.

The configuration of the cooking system in FIG. 13 is different from the one explained above with reference to FIG. 1 in that an ingredient/cooking utensil recognition service server 13 is added. Duplicate descriptions are omitted below where appropriate.

The ingredient/cooking utensil recognition service server 13 is a server that offers the cooking robot 1 a recognition service of recognizing the ingredients and cooking utensils prepared around the cooking robot 1.

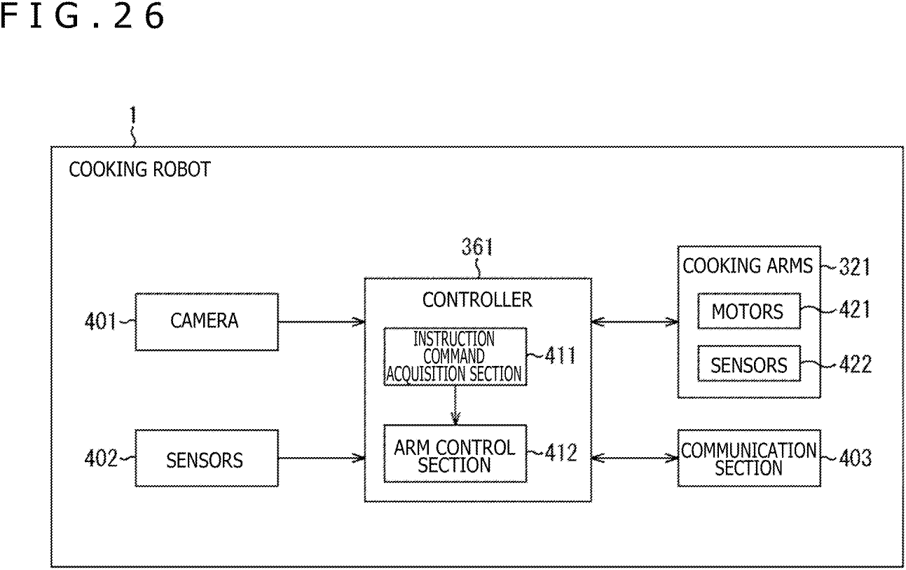

Specifically, in the case where a predetermined ingredient is to be recognized by the recognition operation in a given cooking process, the cooking robot 1 captures an image of nearby objects by use of a camera (camera 401 in FIG. 26) and transmits the captured image to the ingredient/cooking utensil recognition service server 13. Around the cooking robot 1, the ingredients and cooking utensils for use in cooking are prepared by the administrator.

The ingredient/cooking utensil recognition service server 13 recognizes the ingredient (or ingredient type) captured in the image taken by the cooking robot 1, and transmits the result of the recognition to the cooking robot 1.

The cooking robot 1 determines whether or not the ingredient recognized by the ingredient/cooking utensil recognition service server 13 is the exact ingredient stipulated as the target to be recognized for the cooking process.

In the case where the cooking robot 1 determines that the ingredient recognized by the ingredient/cooking utensil recognition service server 13, i.e., the ingredient prepared around the cooking robot 1, is the exact ingredient stipulated as the recognition target, the cooking robot 1 determines that the cooking process is executable. In the case where the ingredient stipulated by the recipe program as the recognition target is not prepared, the cooking process obviously is not executable.

Here, an acceptable range is set for the ingredient subject to the determination of whether or not it is the exact ingredient stipulated as the recognition target.

In the case where the ingredient prepared around the cooking robot 1 is not the exact ingredient stipulated in the recipe program as the recognition target but an ingredient that falls within a designated acceptable range, the cooking robot 1 also determines that the cooking process is executable.

The cooking robot 1 acquires from the module management server 12 the recognition algorithm module for the ingredient recognized by the ingredient/cooking utensil recognition service server 13. The cooking robot 1 executes the acquired recognition algorithm module and, having recognized the ingredient, performs operations such as the cooking operations included in the cooking process.

Likewise, in the case where a predetermined cooking utensil is to be recognized by the recognition operation in a given cooking process, the cooking robot 1 transmits to the ingredient/cooking utensil recognition service server 13 an image captured of the nearby objects by the camera.

The ingredient/cooking utensil recognition service server 13 recognizes the cooking utensil (or cooking utensil type) captured in the image taken by the cooking robot 1, and transmits the result of the recognition to the cooking robot 1.

The cooking robot 1 determines whether or not the cooking utensil recognized by the ingredient/cooking utensil recognition service server 13 is the exact cooking utensil stipulated as the recognition target for the cooking process.

In the case where it is determined that the cooking utensil recognized by the ingredient/cooking utensil recognition service server 13, i.e., the cooking utensil prepared around the cooking robot 1, is the exact cooking utensil stipulated as the recognition target, the cooking robot 1 determines that the cooking process is executable. In the case where the exact cooking utensil stipulated as the recognition target in the recipe program is not prepared, the cooking process obviously is not executable.

Here, an acceptable range is also set for the cooking utensil subject to the determination of whether or not it is the exact cooking utensil stipulated as the recognition target.

In the case where the cooking utensil prepared around the cooking robot 1 is not the exact cooking utensil stipulated in the recipe program as the recognition target but a cooking utensil that falls within the designated acceptable range for the cooking utensil, the cooking robot 1 also determines that the cooking process is executable.

The cooking robot 1 acquires from the module management server 12 the recognition algorithm module for the cooking utensil recognized by the ingredient/cooking utensil recognition service server 13. The cooking robot 1 executes the acquired recognition algorithm module and, having recognized the cooking utensil, performs operations such as the cooking operations included in the cooking process.

In the case where the cooking operation module differs depending on the target, not only the recognition algorithm module but also the cooking operation module for the target prepared around the cooking robot 1 may be acquired from the module management server 12.

Unlike the case of ordinary robots performing operations, there are variations in the ingredients and cooking utensils for use by the cooking robot 1 executing the recipe program to carry out the operations in the cooking process. For example, even in the case where the same dish is to be cooked, the prepared ingredients may vary by the day or depending on the shop. The available cooking utensils and equipment may also vary depending on the environment in which the cooking robot 1 is installed.

It is inefficient if the recipe store server 11 is made to prepare a different recipe program for each of the slightly different ingredients and cooking utensils that are taken into account for their small differences.

When the acceptable range is set for the recognition target and an appropriate module is dynamically acquired and executed by the cooking robot 1 with regard to an actually given object, it is possible to provide recipe programs that are flexible.

That is, the recipe programs can become programs that are executable in diverse environments. With diverse ingredients allowed to be used, there will be more variations in the dishes that can be served.

While it has been explained above that the targets subject to the recognition operation are both the ingredients and the cooking utensils, it is also possible to set either the ingredients or the cooking utensils as the targets to be recognized.

### Specific Examples of the Acceptable Ranges

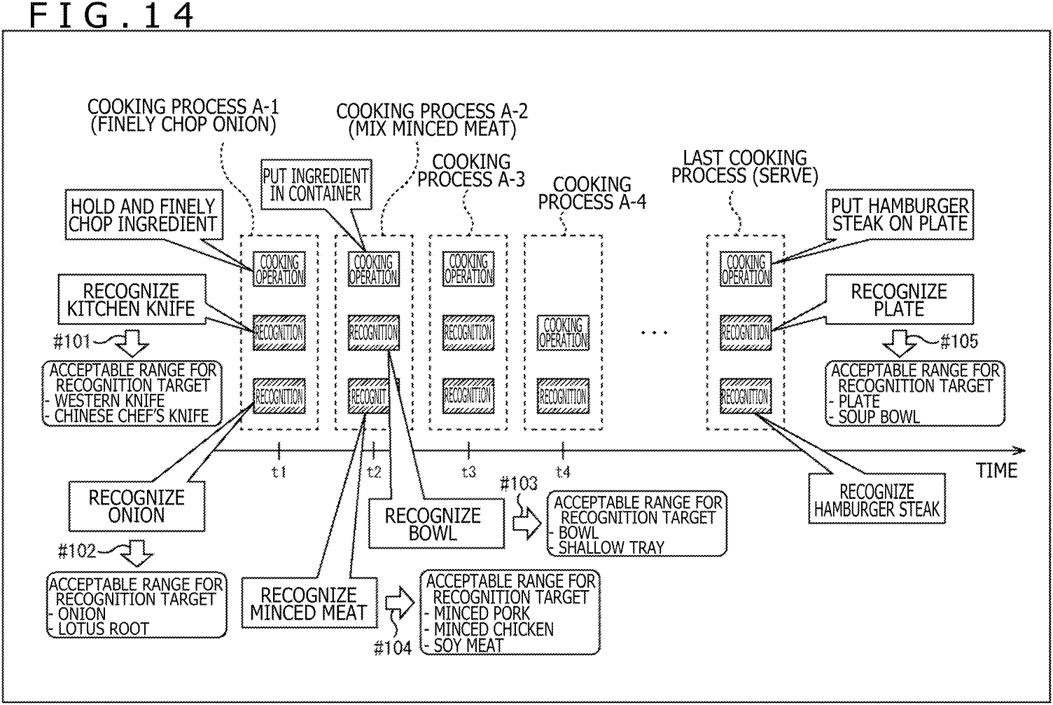

FIG. 14 is a diagram depicting specific examples of the acceptable ranges for recognition targets.

FIG. 14 depicts the cooking processes based on the recipe program of “hamburger steak” explained above with reference to FIG. 6. The cooking process A-1 of “finely chopping an onion” includes the cooking operation of “holding and finely chopping the ingredient” and the recognition operations of “recognizing a kitchen knife” and “recognizing an onion.”

The cooking process A-2 of “mixing minced meat” includes the cooking operation of “putting the ingredient in a container” and the recognition operations of “recognizing a bowl” and “recognizing minced meat.” Likewise, the last cooking process of “serving” includes a cooking operation of “putting the hamburger steak on a plate” and recognition operations of “recognizing a plate” and “recognizing the hamburger steak.”

As pointed to by arrow #101, a “Western knife” and a “Chinese chef’s knife” are set as the targets that fall within the acceptable range for the “kitchen knife” as the recognition target for the recognition operation of “recognizing a kitchen knife” included in the cooking process of “finely chopping an onion.”

Also, as pointed to by arrow #102, not only an “onion” but also a “lotus root” is set as the target that falls within the acceptable range for the “onion” as the recognition target for the recognition operation of “recognizing an onion” included in the cooking process A-1 of “finely chopping an onion.”

The cooking process A-1 of “finely chopping an onion” may involve using either the “Western knife” or the “Chinese chef’s knife” as the cooking utensil. The cooking process A-1 of “finely chopping an onion” may also involve using the “lotus root” besides the “onion” as the ingredient.

Likewise, as pointed to by arrow #103, not only a “bowl” but a “shallow tray” is set as the target that falls within the acceptable range for the “bowl” as the recognition target for the recognition operation of “recognizing a bowl” included in the cooking process A-2 of “mixing minced meat.”

As pointed to by arrow #104, “minced pork,” “minced chicken,” and “soy meat” are set as the targets that fall within the acceptable range for the “minced meat” as the recognition target for the recognition operation of “recognizing minced meat” included in the cooking process A-2 of “mixing minced meat.”

As pointed to by arrow #105, not only a “plate” but also a “soup bowl” is set as the target that falls within the acceptable range for the “plate” as the recognition target for the recognition operation of “recognizing a plate” included in the last cooking process of “serving.”

As described above, the ingredients and cooking utensils as the recognition targets, i.e., ingredients and cooking utensils for use in the cooking process, are each set with an acceptable range. The acceptable range for each target is defined at the time of development of the recognition algorithm modules and cooking operation modules, for example.

For example, the recipe program includes acceptable ingredient range information and acceptable cooking utensil range information associated with each recognition operation, the acceptable ingredient range information representing the ingredients that fall within the acceptable range for each ingredient as a recognition target, the acceptable cooking utensil range information denoting the cooking utensils that fall within the acceptable range for each cooking utensil as a recognition target.

Explained hereunder is a specific example of processing executed by each apparatus in the case of executing a cooking process of “cutting a pumpkin” on the basis of a recipe program of “boiled pumpkin.” The cooking process of “cutting a pumpkin” requires the ingredient that falls within the acceptable range set for “pumpkin” and the cooking utensil that falls within the acceptable rage set for “cutting knife.”

The cooking robot 1 transmits the image taken by the camera to the ingredient/cooking utensil recognition service server 13, and requests recognition of ingredients and cooking utensils.

The ingredient/cooking utensil recognition service server 13 recognizes the ingredients and cooking utensils captured in the image sent from the cooking robot 1, and transmits the result of the recognition to the cooking robot 1.

The cooking robot 1 references the acceptable ingredient range information regarding “pumpkin” to verify whether or not any ingredient that falls within the acceptable range for “pumpkin” is prepared. Also, the cooking robot 1 references the acceptable cooking utensil range information regarding “cutting knife” to verify whether or not any cooking utensil that falls within the acceptable range for “cutting knife” is prepared.

In the case where the cooking robot 1 verifies that an ingredient that falls within the acceptable range for “pumpkin” and a cooking utensil that falls within the acceptable range for “cutting knife” are prepared, the cooking robot 1 determines that the cooking process of “cutting a pumpkin” is executable.

The cooking robot 1 acquires from the module management server 12 the recognition algorithm modules for the ingredient and cooking utensil recognized by the ingredient/cooking utensil recognition service server 13. The cooking robot 1 executes the acquired recognition algorithm modules to carry out operations of the cooking process of “cutting a pumpkin.”

### Operations of the Cooking Robot

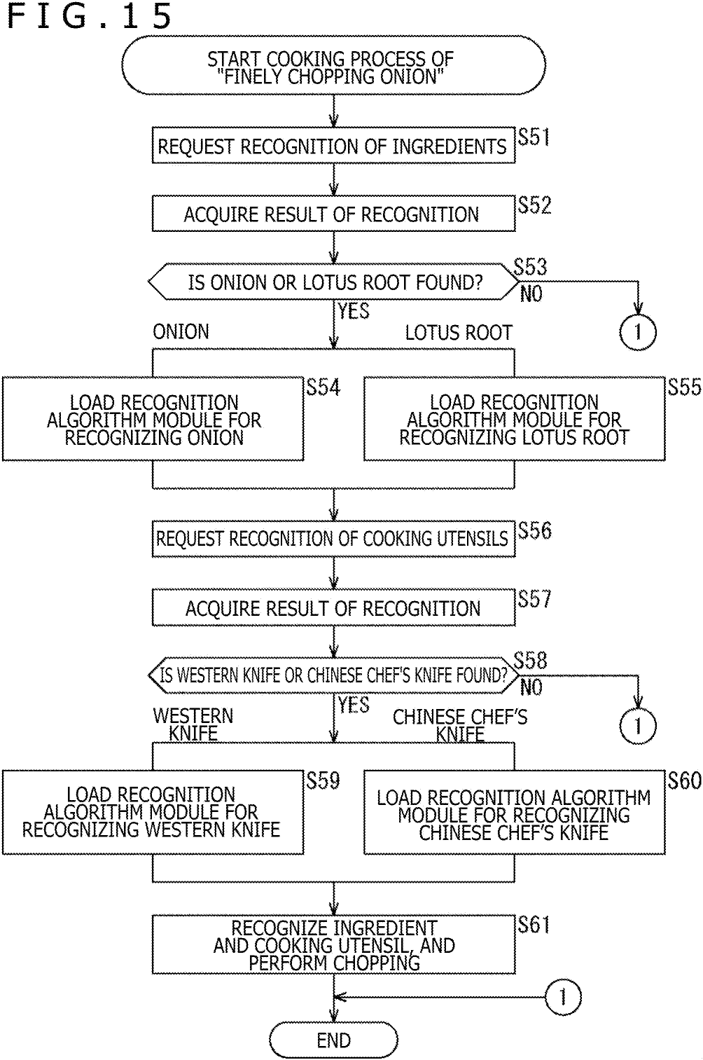

The cooking processes performed by the cooking robot 1 are explained below with reference to the flowchart of FIG. 15. The processing in FIG. 15 is executed, for example, in the case where the cooking process A-1 of “finely chopping an onion” is carried out.

In step S51, the cooking robot 1 transmits the image taken by the camera to the ingredient/cooking utensil recognition service server 13 to request recognition of ingredients. In response to the request from the cooking robot 1, the ingredient/cooking utensil recognition service server 13 recognizes the ingredients.

In step S52, the cooking robot 1 acquires the result of the recognition sent from the ingredient/cooking utensil recognition service server 13.

In step S53, the cooking robot 1 determines whether the recognized ingredient is an onion or a lotus root on the basis of the recognition result sent from the ingredient/cooking utensil recognition service server 13. In this example, the onion and the lotus root are set by the acceptable ingredient range information as the ingredients that fall within the acceptable range.

In the case where it is determined in step S53 that the recognized ingredient is an onion, step S54 is reached. In step S54, the cooking robot 1 acquires (loads) the recognition algorithm module for the onion from the module management server 12.

On the other hand, in the case where it is determined in step S53 that the recognized ingredient is a lotus root, step S55 is reached. In step S55, the cooking robot 1 acquires the recognition algorithm module for the lotus root from the module management server 12.

In the case where it is determined in step S53 that neither the onion nor the lotus root is recognized, error handing is carried out, and the process is terminated. For example, the error handing involves notifying the administrator of the cooking robot 1 that either an onion or a lotus root is to be prepared.

Alternatively, not the types of ingredients but their sizes or their varieties may be recognized by the ingredient/cooking utensil recognition service server 13.

After acquiring the recognition algorithm module for the ingredient, the cooking robot 1 goes to step S56. In step S56, the cooking robot 1 transmits the image taken by the camera to the ingredient/cooking utensil recognition service server 13 to request recognition of cooking utensils. In response to the request from the cooking robot 1, the ingredient/cooking utensil recognition service server 13 recognizes the cooking utensils.

In step S57, the cooking robot 1 acquires the result of the recognition sent from the ingredient/cooking utensil recognition service server 13.

In step S58, the cooking robot 1 determines whether the recognized cooking utensil is a Western knife or a Chinese chef’s knife on the basis of the recognition result sent from the ingredient/cooking utensil recognition service server 13. In this example, the Western knife and the Chinese chef’s knife are set by the acceptable cooking utensil range information as the cooking utensils that fall within the acceptable range.

In the case where it is determined in step S58 that the recognized cooking utensil is a Western knife, step S59 is reached. In step S59, the cooking robot 1 acquires the recognition algorithm module for the Western knife from the module management server 12.

On the other hand, in the case where it is determined in step S58 that the recognized cooking utensil is a Chinese chef’s knife, step S59 is reached. In step S59, the cooking robot 1 acquires the recognition algorithm module for the Chinese chef’s knife from the module management server 12.

In the case where it is determined in step S58 that neither the Western knife nor the Chinese chef’s knife is recognized, error handing is carried out, and the process is terminated. For example, the error handling involves notifying the administrator of the cooking robot 1 that the Western knife or the Chinese chef’s knife is to be prepared.

In step S61, the cooking robot 1 recognizes the ingredient and the cooking utensil as the targets by executing the recognition algorithm modules acquired from the module management server 12. The cooking robot 1 finely chops the recognized ingredient by use of the recognized cooking utensil.

For example, in the case where the “onion” and the “Western knife” are prepared, both are recognized by execution of their recognition algorithm modules. The recognized “onion” is finely chopped by use of the recognized “Western knife.” After the “onion” is finely chopped, the process is terminated.

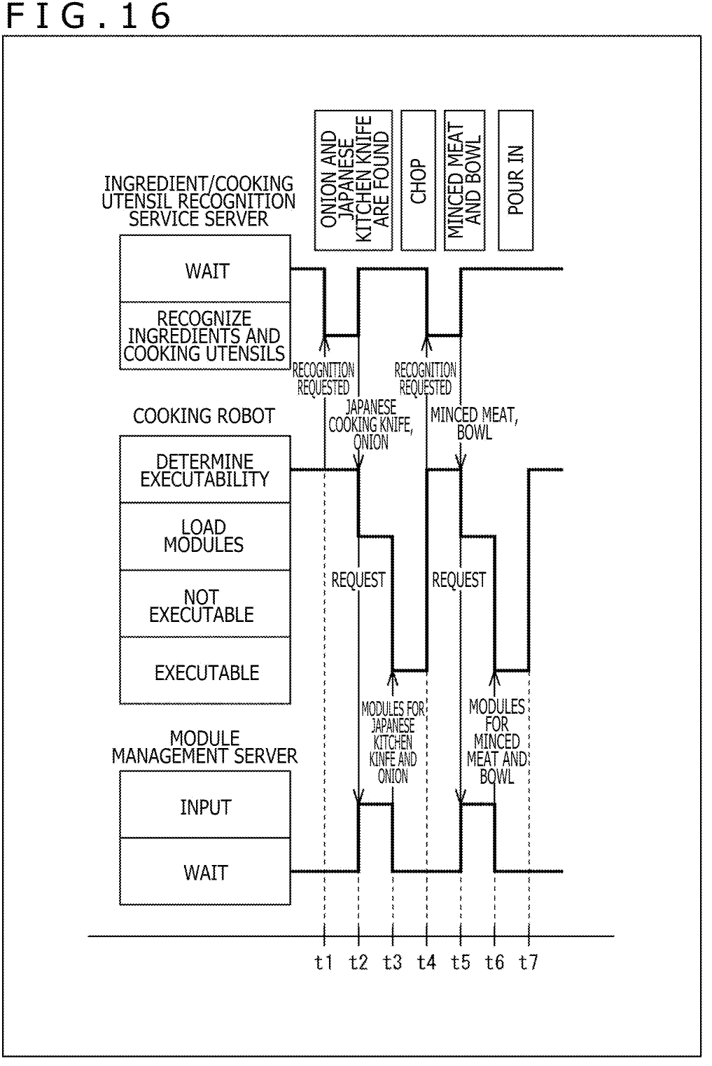

FIG. 16 is a diagram depicting an exemplary timing chart of operations using results of recognition by the ingredient/cooking utensil recognition service server 13.

FIG. 16 depicts timing of the operations performed by the ingredient/cooking utensil recognition service server 13, the cooking robot 1, and the module management server 12 in the case where the cooking process is determined to be executable. The processing indicated in FIG. 16 is carried out prior to each of the recognition operations.

### Time t1

The cooking robot 1 requests the ingredient/cooking utensil recognition service server 13 to recognize the ingredients and cooking utensils prepared around the cooking robot 1. In this example, it is recognized that an “onion” and a “Japanese kitchen knife” are prepared.

### Time t2

The ingredient/cooking utensil recognition service server 13 transmits the result of the recognition to the cooking robot 1.

On the basis of the result of the recognition from the ingredient/cooking utensil recognition service server 13, the cooking robot 1 verifies that the “onion” and the “Japanese kitchen knife” are prepared, and determines that the noted cooking process is executable. The cooking robot 1 requests the recognition algorithm module for “onion” and the recognition algorithm module for “Japanese kitchen knife” from the module management server 12.

### Time t3

In response to the request from the cooking robot 1, the module management server 12 transmits the recognition algorithm module for “onion” and the recognition algorithm module for “Japanese kitchen knife” to the cooking robot 1.

The cooking robot 1 executes the recognition algorithm module for “onion” and the recognition algorithm module for “Japanese kitchen knife” to carry out a cooking operation of cutting the “onion” with the “Japanese kitchen knife.” This cooking operation is continued until time t4, for example.

### Time t4

The cooking robot 1 requests the ingredient/cooking utensil recognition service server 13 to recognize the ingredients and cooking utensils prepared around the cooking robot 1. In this example, it is recognized that “minced meat” and a “bowl” are prepared.

### Time t5

The ingredient/cooking utensil recognition service server 13 transmits the result of the recognition to the cooking robot 1.

On the basis of the result of the recognition from the ingredient/cooking utensil recognition service server 13, the cooking robot 1 verifies that the “minced meat” and the “bowl” are prepared, and determines that the noted cooking process is executable. The cooking robot 1 requests the recognition algorithm module for “minced meat” and the recognition algorithm module for “bowl” from the module management server 12.

### Time t6

In response to the request from the cooking robot 1, the module management server 12 transmits the recognition algorithm module for “minced meat” and the recognition algorithm module for “bowl” to the cooking robot 1.

The cooking robot 1 executes the recognition algorithm module for “minced meat” and the recognition algorithm module for “bowl” to carry out a cooking operation of putting the “minced meat” into the “bowl.” This cooking operation is continued until time t7, for example.

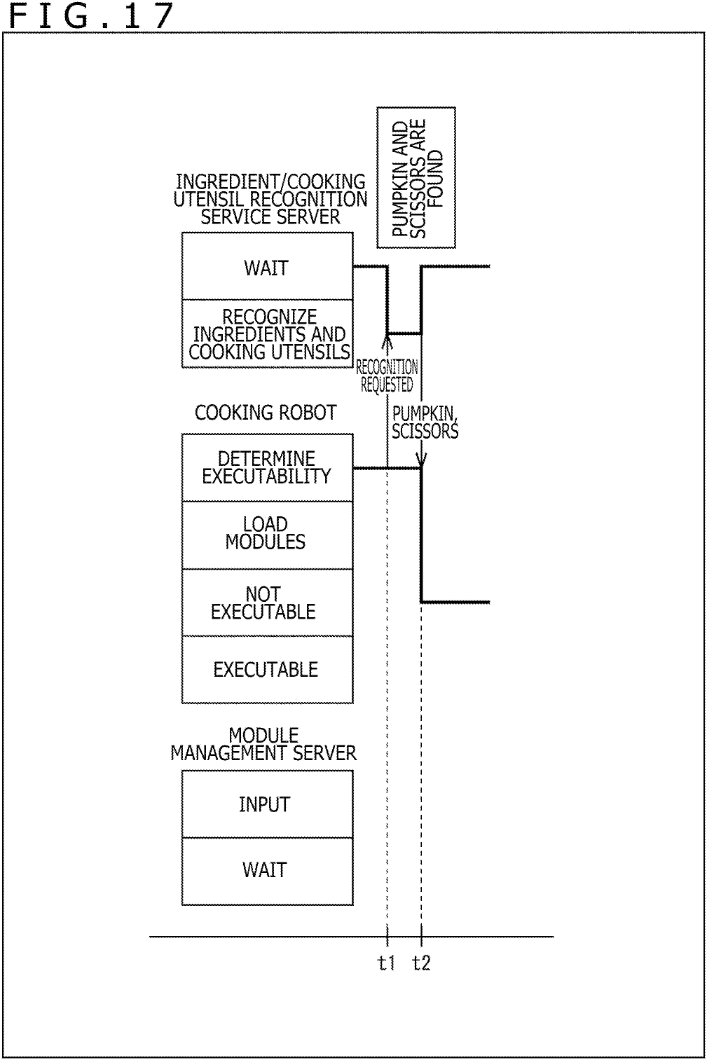

FIG. 17 is a diagram depicting another exemplary timing chart of operations using results of recognition by the ingredient/cooking utensil recognition service server 13.

FIG. 17 depicts timing of the operations performed by the ingredient/cooking utensil recognition service server 13, the cooking robot 1, and the module management server 12 in the case where the cooking process is determined to be not executable.

### Time t1

The cooking robot 1 requests the ingredient/cooking utensil recognition service server 13 to recognize the ingredients and cooking utensils prepared around the cooking robot 1. In this example, it is recognized that a “pumpkin” and “scissors” are prepared.

### Time t2

The ingredient/cooking utensil recognition service server 13 transmits the result of the recognition to the cooking robot 1.

On the basis of the result of the recognition from the ingredient/cooking utensil recognition service server 13, the cooking robot 1 verifies that a “pumpkin” and “scissors” are prepared, and determines that the noted cooking process is not executable. In this example, “scissors” are not a cooking utensil that falls within the acceptable range for the cooking utensil used to cook “pumpkin.” The cooking robot 1 then performs error handling and terminates the process.

The above processing eliminates the need for taking small differences of the ingredients and the cooking utensils into consideration, thereby making the recipe programs more flexible. For the developers of recipe programs, the absence of the need to consider the slightly different ingredients and cooking utensils helps enable efficient development of the recipe programs.

### Configurations of Apparatuses

### Configuration of the Cooking Robot 1

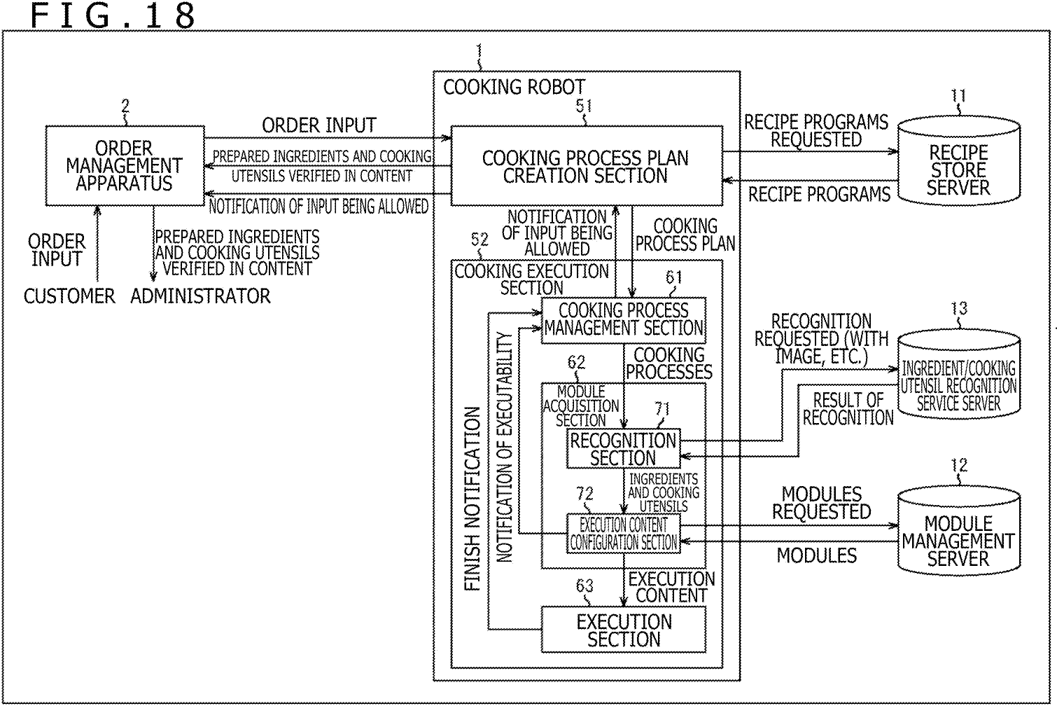

FIG. 18 is a block diagram depicting an exemplary functional configuration of the cooking robot 1.

As depicted in FIG. 18, a cooking process plan creation section 51 and a cooking execution section 52 are implemented in the cooking robot 1. At least some of the constituent elements in FIG. 18 are implemented by a computer that executes relevant programs, the computer being intended to control the cooking robot 1 in operation.

The cooking process plan creation section 51 receives input of an order from the order management apparatus 2, and acquires the recipe program corresponding to the ordered dish from the recipe store server 11. In the case where orders for multiple dishes are received, the cooking process plan creation section 51 acquires from the recipe store server 11 the recipe program for each of the ordered dishes in order to create a cooking process plan. The cooking process plan creation section 51 functions as an acquisition section that acquires the recipe programs for multiple dishes.

That is, the cooking process plan creating process explained above with reference to FIG. 10 is carried out by the cooking process plan creation section 51. The cooking process plan creation section 51 outputs to the cooking execution section 52 the information regarding the cooking process plan created by the cooking process plan creating process, together with the information regarding each of the cooking processes included in the recipe program.

The cooking execution section 52 includes a cooking process management section 61, a module acquisition section 62, and an execution section 63. The module acquisition section 62 includes a recognition section 71 and an execution content configuration section 72. The information regarding each cooking process, output from the cooking process plan creation section 51, is supplied to the components of the cooking execution section 52.

The cooking process management section 61 manages execution of cooking processes on the basis of the cooking process plan created by the cooking process plan creation section 51. For example, the cooking process management section 61 outputs to the recognition section 71 the information regarding the cooking process constituting the target of execution.

The recognition section 71 communicates with the ingredient/cooking utensil recognition service server 13 to recognize the ingredients and cooking utensils prepared around the cooking robot 1. The recognition section 71 transmits an image taken by the camera to the ingredient/cooking utensil recognition service server 13 to request recognition of the ingredients and cooking utensils. The recognition section 71 acquires the result of the recognition from the ingredient/cooking utensil recognition service server 13, and outputs the acquired recognition result to the execution content configuration section 72.

The execution content configuration section 72 determines executability of the cooking process on the basis of the recognition result supplied from the recognition section 71, and notifies the cooking process management section 61 of the result of the determination. For example, in the case where the ingredient and cooking utensil prepared around the cooking robot 1 are the targets that fall within the acceptable range, the execution content configuration section 72 determines that the cooking process is executable.

The execution content configuration section 72 communicates with the module management server 12 to acquire the modules necessary for the recognition and cooking operations included in the cooking process determined to be executable. The execution content configuration section 72 acquires the recognition algorithm module and cooking operation module for the ingredient prepared around the cooking robot 1.

The execution content configuration section 72 outputs the modules acquired from the module management server 12 as the information regarding the content of execution to the execution section 63. The execution content configuration section 72 functions as a determination section that determines whether or not the targets falling within the acceptable range are prepared around the cooking robot 1 and acquires the modules for these targets.

The execution section 63 executes the modules supplied from the execution content configuration section 72, thereby carrying out the recognition and cooking operations included in the cooking process.

For example, the execution section 63 recognizes the ingredient and cooking utensil constituting the targets by executing the recognition algorithm modules. Also, the execution section 63 executes the cooking operation modules to drive the cooking arms or the like and to thereby perform cooking operations using the recognized targets. For example, the cooking arms are driven according to instruction commands output from the execution section 63. The execution section 63 functions as a control section that controls the cooking robot 1 in operation.

Upon completion of the operations of the cooking process, the execution section 63 notifies the cooking process management section 61 that the operations are finished.

In this manner, the cooking execution section 52 performs the determination of executability of the cooking process explained above with reference to FIG. 15. Of the processes described with reference to FIG. 15, those of steps S51, S52, S56, and S57 are carried out by the recognition section 71. The processes of steps S53 through S55 and S58 through S60 are performed by the execution content configuration section 72. The process of step S61 is executed by the execution section 63.

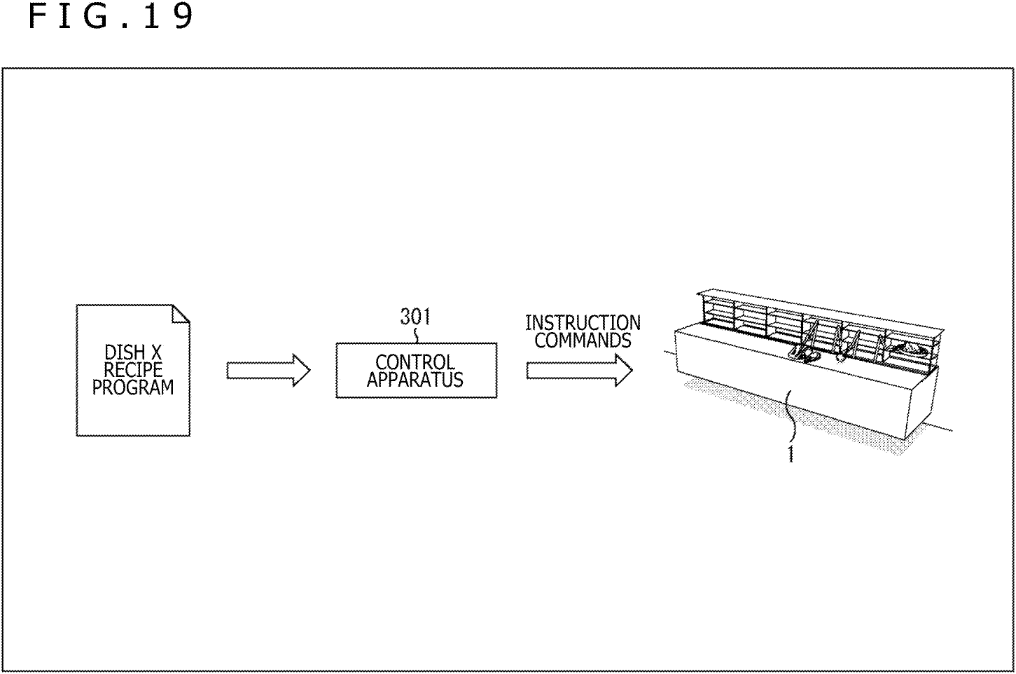

FIG. 19 is a diagram depicting an exemplary configuration on the side of the restaurant.

As depicted in FIG. 19, a control apparatus 301 is installed together with the cooking robot 1 in the restaurant. The control apparatus 301 is a computer that controls the cooking robot 1. By use of the control apparatus 301, it is possible to implement the configuration of the cooking robot 1 explained above with reference to FIG. 18.

The control apparatus 301 outputs to the cooking robot 1 instruction commands based on the description in the recipe program, thereby controlling the cooking robot 1 to cause the cooking robot 1 to perform the operations of the cooking process. The instruction commands include information for controlling torques, drive directions, and drive amounts of motors attached to the cooking arms. The control apparatus 301 outputs the instruction commands successively to the cooking robot 1 until the dish is finished.

According to the instruction commands supplied from the control apparatus 301, the cooking robot 1 drives its various components including the cooking arms to perform the operations of each cooking process.

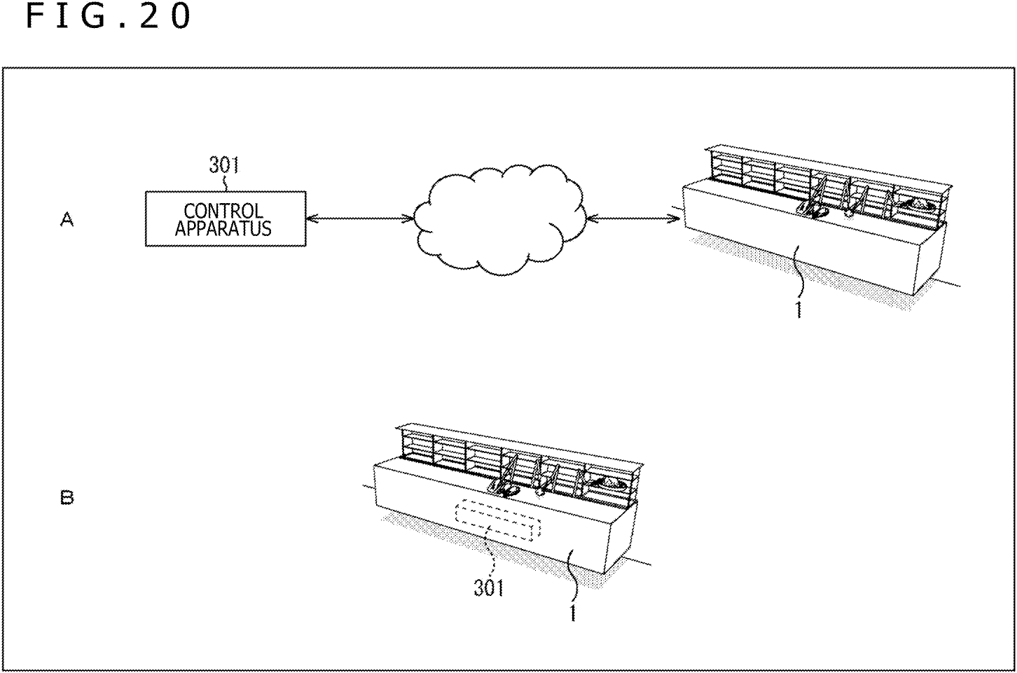

FIG. 20 is a diagram depicting exemplary arrangements of the control apparatus 301.

As indicated in Subfigure A in FIG. 20, the control apparatus 301 may be installed external to the cooking robot 1 and connected therewith via a network such as the Internet. Alternatively, as indicated in Subfigure B in FIG. 20, the control apparatus 301 may be installed inside a housing of the cooking robot 1.

In the case where the control apparatus 301 is installed external to the cooking robot 1, the instruction commands sent from the control apparatus 301 are received by the cooking robot 1 via the network. The cooking robot 1 transmits the image taken by its camera as well as various data including sensor data from the sensors mounted on the cooking robot 1 to the control apparatus 301 via the network.

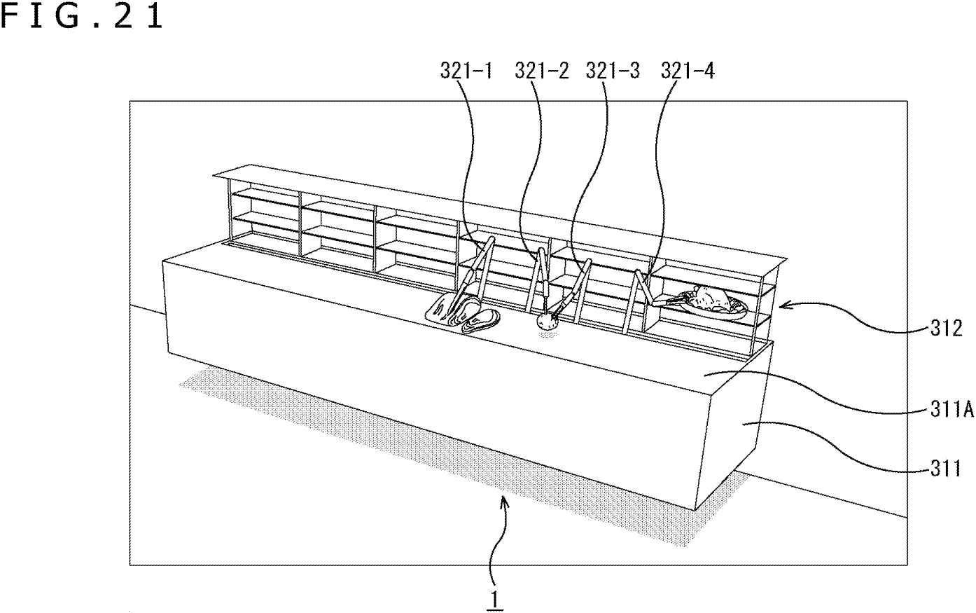

FIG. 21 is a perspective view depicting an appearance of the cooking robot 1.

As depicted in FIG. 21, the cooking robot 1 is a kitchen-like robot in a horizontally elongated cuboid housing 311. Various constituent elements are provided inside the housing 311 that forms a main body of the cooking robot 1.

On a back side of the housing 311 is a kitchen assistant system 312. Spaces segmented by thin platelike members in the kitchen assistant system 312 have a function of assisting in cooking with cooking arms 321-1 through 321-4, the spaces providing functions of a refrigerator, a microwave convection oven, and a storage room, for example.

A countertop 311A is furnished, in its longitudinal direction, with rails on which the cooking arms 321-1 through 321-4 are mounted. The arms 321-1 through 321-4 can change their positions by moving along the rails constituting a moving mechanism.

The cooking arms 321-1 through 321-4 are robotic arms formed by joints that connect cylindrical members with one another. Various types of work related to cooking are performed by the cooking arms 321-1 through 321-4.

The space above the countertop 311A is a cooking space in which the cooking arms 321-1 through 321-4 perform the cooking.

While FIG. 21 indicates four cooking arms, the number of cooking arms is not limited to four. In the case where there is no need to distinguish the cooking arms 321-1 through 321-4 from each other in the ensuing description, they are collectively referred to as the cooking arms 321.

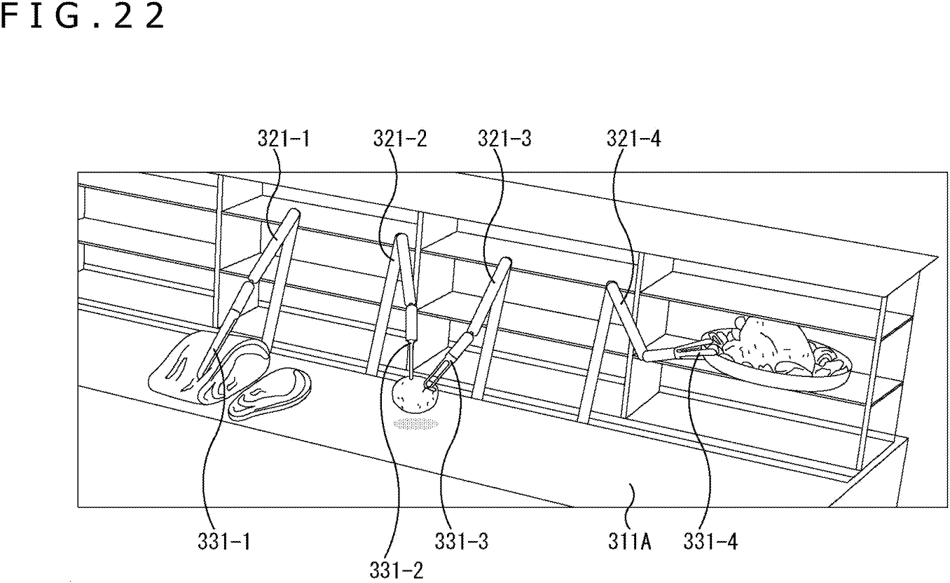

FIG. 22 is an enlarged view of the cooking arms 321.

As depicted in FIG. 22, the cooking arms 321 are tipped with attachments that have various cooking functions. The diverse attachments for the cooking arms 321 include an attachment that functions as a manipulator (i.e., hand function) gripping ingredients and cooking utensils and an attachment that functions as a knife for cutting ingredients.

In the example of FIG. 22, the cooking arm 321-1 is furnished with a knife attachment 331-1 that provides the knife function. The knife attachment 331-1 is used to cut a chunk of meat placed on the countertop 311A.

The cooking arm 321-2 is furnished with a spindle attachment 331-2 for use in holding or rotating an ingredient.

The cooking arm 321-3 is furnished with a peeler attachment 331-3 that provides a function of a peeler peeling the skin of an ingredient.

The skin of a potato held up by the cooking arm 321-2 using the spindle attachment 331-2 is peeled by the cooking arm 321-3 using the peeler attachment 331-3. In this manner, multiple cooking arms 321 may operate in collaboration to perform a single task.

The cooking arm 321-4 is furnished with a manipulator attachment 331-4 that provides the manipulator function. The manipulator attachment 331-4 is used to bring a frying pan with a chicken inside into the space of the kitchen assistant system 312 providing an oven function.

The cooking with such cooking arms 321 proceeds with the attachments changed as needed depending on work details. It is also possible to furnish multiple cooking arms 321 with the same type of attachment, such as when the four cooking arms 321 are each furnished with the manipulator attachment 331-4.

The cooking with the cooking robot 1 is carried out not only by use of the above-described attachments prepared as tools for the cooking arms but also by use of tools the same as those used by humans for cooking as needed. For example, a knife for human use is grabbed by the manipulator attachment 331-4 and used for cooking such as for cutting ingredients.

### Configuration of the Cooking Arms

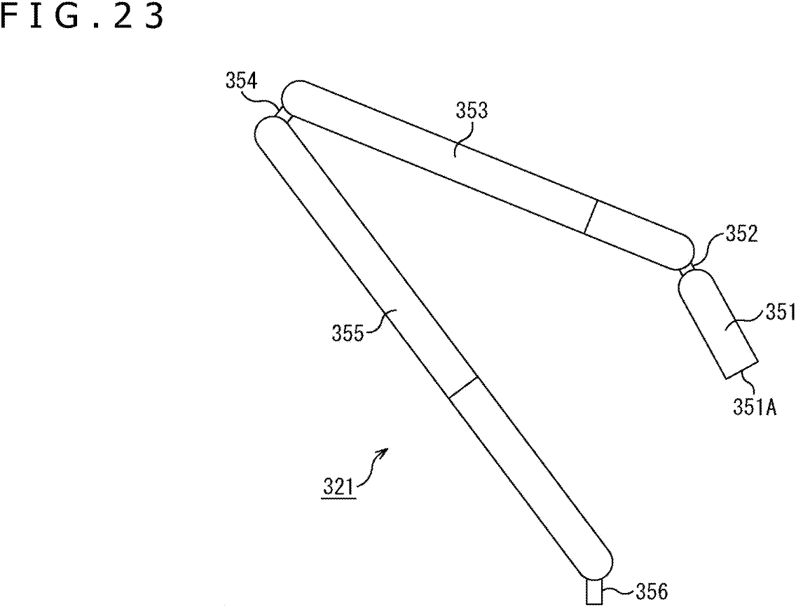

FIG. 23 is a diagram depicting an appearance of the cooking arm 321.

As depicted in FIG. 23, the cooking arm 321 as a whole is constituted by thin cylindrical members connected with hinge parts acting as joints. Each of the hinge parts is furnished, for example, with a motor that produces power to drive the members.

The cylindrical members include, from the tip upward, an attaching/detaching member 351, a relay member 353, and a base member 355.

A hinge part 352 connects the attaching/detaching member 351 with the relay member 353. A hinge part 354 connects the relay member 353 with the base member 355.

A tip of the attaching/detaching member 351 is furnished with an attaching/detaching part 351A to and from which an attachment is attached and detached. The attaching/detaching member 351, furnished with the attaching/detaching part 351A to and from which any one of diverse attachments is attached and detached, functions as a cooking-function arm part that performs cooking by operating the attachment.

A back end of the base member 355 is furnished with an attaching/detaching part 356 to be attached to the rails. The base member 355 functions as a movingfunction arm part that moves the cooking arm 321.

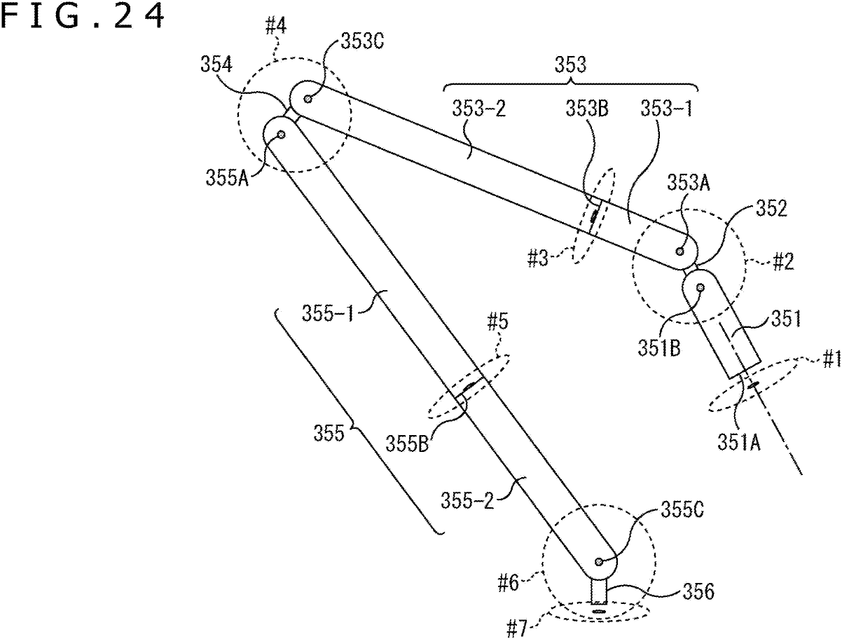

FIG. 24 is a diagram depicting exemplary movable ranges of parts of the cooking arm 321.

As indicated enclosed by ellipse #1, the attaching/detaching member 351 is made rotatable around a central axis of a circular cross-section. A small flat circle at the center of the ellipse #1 indicates a direction of a dashed-line rotation axis.

As indicated enclosed by circle #2, the attaching/detaching member 351 is made rotatable around an axis through an interlocking part 351B interlocked with the hinge part 352. The relay member 353 is made rotatable around an axis through an interlocking part 353A interlocked with the hinge part 352.

Two small circles inside the circle #2 each denote a direction of a rotation axis (direction perpendicular to the page). A movable range for the attaching/detaching member 351 centering on the axis through the interlocking part 351B is 90 degrees, for example, and so is a movable range for the relay member 353 centering on the axis through the interlocking part 353A.

The relay member 353 includes a front-end side member 353-1 and a back-end side member 353-2, which are separated from each other. As indicated enclosed by ellipse #3, the relay member 353 is made rotatable around a central axis of a circular cross-section at a connecting part 353B between the members 353-1 and 353-2. The other movable members basically have similar movable ranges.

As described above, the hinge parts rotatably connect the attaching/detaching member 351, the relay member 353, and the base member 355, the attaching/detaching member 351 being tipped with the attaching/detaching part 351A, the relay member 353 coupling the attaching/detaching member 351 with the base member 355, the base member 355 being connected with the attaching/detaching part 356 at its end. Each of the movable parts is controlled in motion by a controller in the cooking robot 1 according to instruction commands.

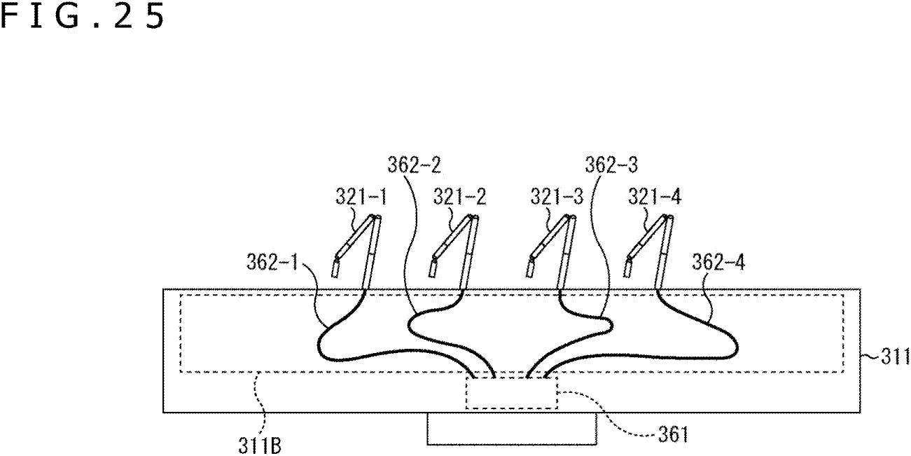

FIG. 25 is a diagram depicting exemplary connections between the cooking arms and a controller.

As depicted in FIG. 25, the cooking arms 321 and a controller 361 are interconnected by wires in a space 311B defined inside the housing 311. In the example of FIG. 25, the cooking arms 321-1 through 321-4 are connected with the controller 361 by wires 362-1 through 362-4, respectively. The wires 362-1 through 362-4, which are flexible, bend as needed in keeping with the positions of the cooking arms 321-1 through 321-4.

FIG. 26 is a block diagram depicting an exemplary configuration of the cooking robot 1.

The cooking robot 1 includes the components connected with the controller 361. Of the constituent elements depicted in FIG. 26, the same elements as those discussed above are designated by the same reference signs. Duplicate descriptions are omitted where appropriate.

The controller 361 is connected with a camera 401, sensors 402, and a communication section 403 in addition to the cooking arms 321.

The controller 361 includes a computer that includes a CPU, a ROM, a RAM, a flash memory, and the like. The controller 361 causes the CPU to execute predetermined programs to control the entire operation of the cooking robot 1.

For example, the controller 361 controls the communication section 403 to cause the communication section 403 to transmit to the control apparatus 301 images taken by the camera 401 and sensor data measured by the sensors 402.

The controller 361 implements an instruction command acquisition section 411 and an arm control section 412 by executing relevant programs.

The instruction command acquisition section 411 acquires instruction commands that are sent from the control apparatus 301 and are received by the communication section 403. The instruction commands acquired by the instruction command acquisition section 411 are supplied to the arm control section 412.

The arm control section 412 controls the cooking arms 321 in operation, according to the instruction commands acquired by the instruction command acquisition section 411.

The camera 401 captures an image of the surroundings of the cooking robot 1 and outputs the captured image to the controller 361. The camera 401 may be positioned diversely, such as directly in front of the cooking assistant system 312 or at the tip of any one of the cooking arms 321.

The sensors 402 include diverse types of sensors including a thermo-hygro sensor, a pressure sensor, a photosensor, a distance sensor, a human presence sensor, a positioning sensor, and a vibration sensor. Measurements are taken by the sensors 402 at predetermined intervals. The sensor data indicative of the results of the measurements by the sensors 402 is supplied to the controller 361.

The camera 401 and the sensors 402 may be positioned away from the housing 311 of the cooking robot 1.

The communication section 403 is a wireless communication module such as a mobile communication module that supports LTE (Long Term Evolution). The communication section 403 communicates with an external apparatus.

Motors 421 and sensors 422 are attached to the cooking arms 321.

The motors 421 are mounted on the joints of the cooking arms 321. Each motor 421 rotates around an axis under control of the arm control section 412. Also mounted on the joints are encoders that measure rotation amounts of the motors 421 and drivers that adaptively control the rotations of the motors 421 on the basis of the results of the measurements by the encoders.

The sensors 422 include a gyro sensor, an acceleration sensor, and a touch sensor, for example. During operation of the cooking arms 321, the sensors 422 measure angular velocity, acceleration, and the like of each of the joints and outputs information indicative of the results of the measurements to the controller 361. The cooking robot 1 also transmits to the control apparatus 301 the sensor data indicative of the results of the measurements by the sensors 422 as needed.

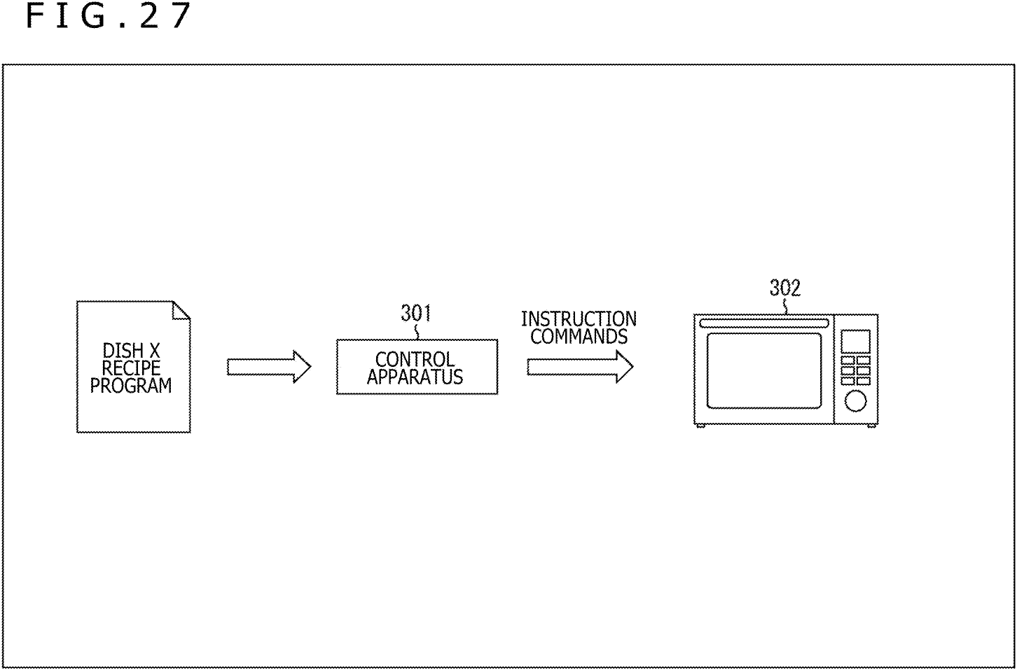

FIG. 27 is a diagram depicting an exemplary device as a control target.

An electronic cooking utensil 302 is a device such as a microwave oven. The electronic cooking utensil 302 performs cooking by carrying out cooking operations according to the instruction commands supplied from the control apparatus 301.

As described above, it is possible to use recipe programs to control various devices that perform the cooking operations automatically. That is, the apparatus as the target for control by the recipe programs is not limited to the cooking robot 1 that performs the cooking by driving its cooking arms.

### Configurations of the Servers

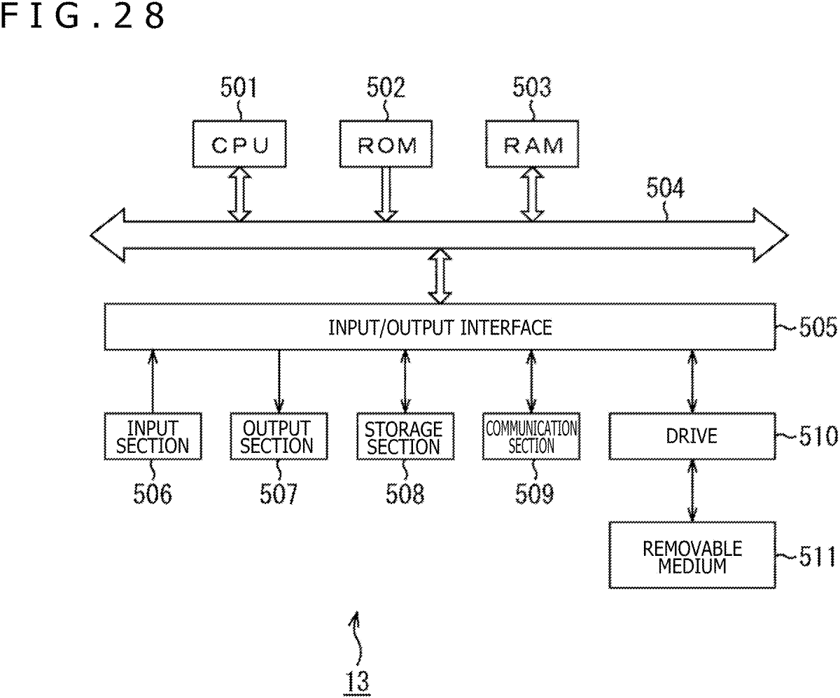

FIG. 28 is a block diagram depicting an exemplary hardware configuration of the ingredient/cooking utensil recognition service server 13.

As depicted in FIG. 28, the ingredient/cooking utensil recognition service server 13 includes a computer. Likewise, the recipe store server 11 and the module management server 12 each include a computer such as one depicted in FIG. 28.

A single computer may implement the servers ranging from the recipe store server 11 to the ingredient/cooking utensil recognition service server 13. Alternatively, each of these servers may be implemented by a different computer. As another alternative, the same computer may implement at least two of the servers ranging from the recipe store server 11 to the ingredient/cooking utensil recognition service server 13 in combination.

A CPU (Central Processing Unit) 501, a ROM (Read Only Memory) 502, and a RAM (Random Access Memory) 503 are interconnected by a bus 504.

The bus 504 is further connected with an input/output interface 505. The input/output interface 505 is connected with an input section 506 including a keyboard, a mouse, and the like and an output section 507 including a display unit, a speaker, and the like.

The input/output interface 505 is also connected with a storage section 508 including a hard disk, a nonvolatile memory, and the like, with a communication section 509 including a network interface and the like, and with a drive 510 that drives a removable medium 511.

The CPU 501 performs diverse processes including recipe program management by loading appropriate programs from the storage section 508, for example, into the RAM 503 via the input/output interface 505 and the bus 504 and by executing the loaded programs.

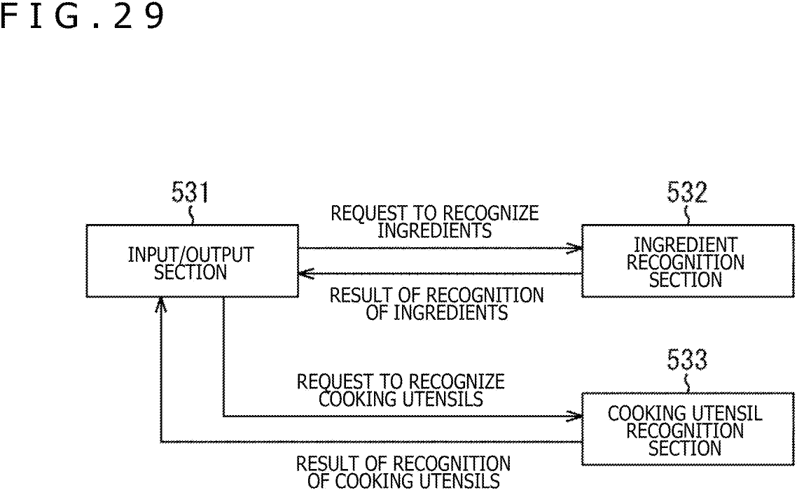

FIG. 29 is a block diagram depicting an exemplary functional configuration of the ingredient/cooking utensil recognition service server 13. At least some of the functional sections depicted in FIG. 29 are implemented by the CPU 501 in FIG. 28 executing relevant programs.

In the ingredient/cooking utensil recognition service server 13, an input/output section 531, an ingredient recognition section 532, and a cooking utensil recognition section 533 are implemented.

The input/output section 531 communicates with the recognition section 71 (FIG. 18) and receives therefrom requests to recognize ingredients and cooking utensils. The requests sent from the recognition section 71 include the image taken by the camera 401. The input/output section 531 outputs an ingredient recognition request to the ingredient recognition section 532 and a cooking utensil recognition request to the cooking utensil recognition section 533.

The input/output section 531 transmits to the recognition section 71 the result of the recognition of ingredients sent from the ingredient recognition section 532. Also, the input/output section 531 transmits to the recognition section 71 the result of the recognition of cooking utensils sent from the cooking utensil recognition section 533.

The ingredient recognition section 532 analyzes the image supplied from the input/output section 531 to recognize the ingredients prepared around the cooking robot 1. The ingredient recognition section 532 outputs the result of the recognition of the ingredients to the input/output section 531.

The cooking utensil recognition section 533 analyzes the image supplied from the input/output section 531 to recognize the cooking utensils prepared around the cooking robot 1. The cooking utensil recognition section 533 outputs the result of the recognition of the cooking utensils to the input/output section 531.

Incidentally, the cooking utensils that may be recognized by the cooking utensil recognition section 533 include tools for processing ingredients such as knives, pots, frying pans, ladles, spatulas, and tongs, as well as tableware including plates and cups for serving purposes. The cooking utensils further include cutlery, electronic cooking devices, and the like. That is, the cooking utensils include various tools for use in different stages of cooking.

### Others

The dishes cooked on the basis of the recipe programs are not limited to those prepared by combining various ingredients such as the meals offered by restaurants. Preferably, sweets may be made in accordance with the recipe programs. As another alternative, beverages such as alcoholic drinks and coffee may be prepared in like manner.

### Programs

The series of the processes described above may be executed either by hardware or by software. In the case where a software-based series of processing is to be carried out, the programs constituting the software are installed into a suitable computer built with dedicated hardware or into a general-purpose personal computer or like equipment.

The programs to be installed may be provided recorded on removable media including optical discs (CD-ROM (Compact Disc-Read Only Memory), DVD (Digital Versatile Disc), and the like) or semiconductor memories, for example. The programs may alternatively be provided through wired or wireless communication media such as local area networks, the Internet, or digital broadcasts.

The programs executed by the computer may each be processed chronologically, i.e., in the sequence explained in this description, in parallel with other programs, or in otherwise appropriately timed fashion such as when the program is invoked as needed.

Incidentally, in this description, the term “system” refers to an aggregate of multiple components (e.g., apparatuses or modules (parts)). It does not matter whether or not all components are housed in the same enclosure. Thus, a system may include multiple apparatuses housed in separate enclosures and interconnected via a network, or include a single apparatus in a single enclosure that houses multiple modules.

The advantageous effects stated in this description are only examples and not limitative of the present technology that may provide other advantages as well.

The present technology is not limited to the preferred embodiments discussed above and can be implemented in diverse variations so far as they are within the scope of the present technology.

For example, the present technology can be implemented as a cloud computing setup in which a single function is processed cooperatively by networked multiple apparatuses on a shared basis.

Also, each of the steps discussed in reference to the above-described flowcharts can be executed either by a single apparatus or by multiple apparatuses on a shared basis.

Furthermore, in the case where a single step includes multiple processes, these processes can be executed either by a single apparatus or by multiple apparatuses on a shared basis.

### Exemplary Combinations of the Configured Components

The present technology can be configured preferably as follows.
(1) A control apparatus including:
   a cooking process plan creation section configured to acquire multiple recipe programs each prepared for a dish to be finished by a cooking robot going through multiple cooking processes, thereby creating a cooking process plan on the basis of a resource required for each of the cooking processes; and
   a control section configured to cause the cooking robot to parallelly execute those of the cooking processes that are parallelly executable for cooking different dishes, on the basis of the cooking process plan.
(2) The control apparatus as stated in paragraph (1) above,
   in which the recipe programs each include resource information indicating a resource required for an operation constituting each of the cooking processes, and
   the cooking process plan creation section calculates the resource required for each of the cooking processes on the basis of the resource information, thereby specifying the parallelly executable cooking processes.
(3) The control apparatus as stated in paragraph (1) or (2) above, in which, after starting the cooking processes based on the recipe program for a given dish, the cooking process plan creation section creates the cooking process plan in response to acquisition of the recipe program for another dish.
(4) The control apparatus as stated in paragraph (3) above, in which the cooking process plan creation section specifies the operations of the parallelly executable cooking processes, according to the remaining cooking processes based on the initially acquired recipe program and the cooking processes based on the subsequently acquired recipe program.
(5) The control apparatus as stated in paragraph (3) or (4) above, in which the cooking process plan creation section creates the cooking process plan in such a manner that the dish based on the initially acquired recipe program will be finished before the dish based on the subsequently acquired recipe program.
(6) The control apparatus as stated in paragraph (2) above, in which the resource information includes at least either information indicating an occupancy rate of a calculation section required for executing the operations of the cooking processes or information denoting a hardware configuration.
(7) The control apparatus as stated in paragraph (6) above, in which the resource information further includes information indicating a time period required for the operation constituting each of the cooking processes.
(8) The control apparatus as stated in any one of paragraphs (1) through (7) above, in which the cooking process plan creation section creates the cooking process plan on the basis of a constraint reflecting an environment in which the cooking robot is installed.
(9) The control apparatus as stated in paragraph (8) above, in which the constraint reflecting the environment in which the cooking robot is installed includes a constraint on an ingredient and a constraint on a cooking utensil.
(10) The control apparatus as stated in any one of paragraphs (1) through (9) above, in which an operation constituting each of the cooking processes includes a recognition operation for recognizing a target and a cooking operation that uses the recognized target and that is performed by the cooking robot driving a cooking arm attached thereto.
(11) A control method performed by a control apparatus that controls a cooking robot in operation, the control method including:
   acquiring multiple recipe programs each prepared for a dish to be finished by the cooking robot going through multiple cooking processes;
   creating a cooking process plan on the basis of a resource required for each of the cooking processes; and
   causing the cooking robot to parallelly execute those of the cooking processes that are parallelly executable for cooking different dishes, on the basis of the cooking process plan.
(12) A control apparatus including:
   an acquisition section configured to acquire multiple recipe programs each prepared for a dish to be finished by a cooking robot going through multiple cooking processes; and
   a control section configured to execute, in a case where there is prepared a target that falls within an acceptable range for a target stipulated by the recipe program to be used in an operation constituting a cooking process, a program module for the target falling within the acceptable range, thereby causing the cooking robot to execute the operation using the target falling within the acceptable range.
(13) The control apparatus as stated in paragraph (12) above, in which the target is at least either an ingredient or a cooking utensil used for cooking.
(14) The control apparatus as stated in paragraph (12) or (13) above, further including:
   a recognition section configured to transmit an image captured by the cooking robot to a first server that offers a service of recognizing the target, and acquire a result of recognition of the target prepared for the cooking robot.
(15) The control apparatus as stated in paragraph (14) above, further including:
   a determination section configured to determine whether or not the target falling within the acceptable range is prepared, on the basis of the result of the recognition of the target, and in a case where it is determined that the target falling within the acceptable range is prepared, acquire from a second server a program module for the target falling within the acceptable range.
(16) The control apparatus as stated in paragraph (15) above,
   in which each of the targets stipulated by the recipe program to be used for the operations constituting the cooking processes is associated with acceptable range information indicative of a target that falls within the acceptable range, and
   the determination section determines whether or not the target falling within the acceptable range is prepared, by use of the acceptable range information.
(17) A control method performed by a control apparatus that controls a cooking robot in operation, the control method including:
   acquiring multiple recipe programs each prepared for a dish to be finished by the cooking robot going through multiple cooking processes;
   executing, in a case where there is prepared a target that falls within an acceptable range for a target stipulated by the recipe program to be used in an operation constituting a cooking process, a program module for the target falling within the acceptable range; and
   causing the cooking robot to execute the operation using the target falling within the acceptable range.

### Reference Signs List

1: Cooking robot
2: Order management apparatus
11: Recipe store server
12: Module management server
13: Ingredient/cooking utensil recognition service server
51: Cooking process plan creation section
52: Cooking execution section
61: Cooking process management section
62: Module acquisition section
63: Execution section
71: Recognition section
72: Execution content configuration section

1. A control apparatus comprising:
a cooking process plan creation section configured to acquire multiple recipe programs each prepared for a dish to be finished by a cooking robot going through multiple cooking processes, thereby creating a cooking process plan on a basis of a resource required for each of the cooking processes; and
a control section configured to cause the cooking robot to parallelly execute those of the cooking processes that are parallelly executable for cooking different dishes, on a basis of the cooking process plan.

2. The control apparatus according to claim 1,
wherein the recipe programs each include resource information indicating a resource required for an operation constituting each of the cooking processes, and
the cooking process plan creation section calculates the resource required for each of the cooking processes on a basis of the resource information, thereby specifying the parallelly executable cooking processes.

3. The control apparatus according to claim 1,
wherein, after starting the cooking processes based on the recipe program for a given dish, the cooking process plan creation section creates the cooking process plan in response to acquisition of the recipe program for another dish.

4. The control apparatus according to claim 3,
wherein the cooking process plan creation section specifies the operations of the parallelly executable cooking processes, according to the remaining cooking processes based on the initially acquired recipe program and the cooking processes based on the subsequently acquired recipe program.

5. The control apparatus according to claim 3,
wherein the cooking process plan creation section creates the cooking process plan in such a manner that the dish based on the initially acquired recipe program will be finished before the dish based on the subsequently acquired recipe program.

6. The control apparatus according to claim 2,
wherein the resource information includes at least either information indicating an occupancy rate of a calculation section required for executing the operations of the cooking processes or information denoting a hardware configuration.

7. The control apparatus according to claim 6,
wherein the resource information further includes information indicating a time period required for the operation constituting each of the cooking processes.

8. The control apparatus according to claim 1,
wherein the cooking process plan creation section creates the cooking process plan on a basis of a constraint reflecting an environment in which the cooking robot is installed.

9. The control apparatus according to claim 8,
wherein the constraint reflecting the environment in which the cooking robot is installed includes a constraint on an ingredient and a constraint on a cooking utensil.

10. The control apparatus according to claim 1,
wherein an operation constituting each of the cooking processes includes a recognition operation for recognizing a target and a cooking operation that uses the recognized target and that is performed by the cooking robot driving a cooking arm attached thereto.

11. A control method performed by a control apparatus that controls a cooking robot in operation, the control method comprising:
acquiring multiple recipe programs each prepared for a dish to be finished by the cooking robot going through multiple cooking processes;
creating a cooking process plan on a basis of a resource required for each of the cooking processes; and
causing the cooking robot to parallelly execute those of the cooking processes that are parallelly executable for cooking different dishes, on a basis of the cooking process plan.

12. A control apparatus comprising:
an acquisition section configured to acquire multiple recipe programs each prepared for a dish to be finished by a cooking robot going through multiple cooking processes; and
a control section configured to execute, in a case where there is prepared a target that falls within an acceptable range for a target stipulated by the recipe program to be used in an operation constituting a cooking process, a program module for the target falling within the acceptable range, thereby causing the cooking robot to execute the operation using the target falling within the acceptable range.

13. The control apparatus according to claim 12,
wherein the target is at least either an ingredient or a cooking utensil used for cooking.

14. The control apparatus according to claim 12, further comprising:
a recognition section configured to transmit an image captured by the cooking robot to a first server that offers a service of recognizing the target, and acquire a result of recognition of the target prepared for the cooking robot.

15. The control apparatus according to claim 14, further comprising:
a determination section configured to determine whether or not the target falling within the acceptable range is prepared, on a basis of the result of the recognition of the target, and in a case where it is determined that the target falling within the acceptable range is prepared, acquire from a second server a program module for the target falling within the acceptable range.

16. The control apparatus according to claim 15,
wherein each of the targets stipulated by the recipe program to be used for the operations constituting the cooking processes is associated with acceptable range information indicative of a target that falls within the acceptable range, and
the determination section determines whether or not the target falling within the acceptable range is prepared, by use of the acceptable range information.

17. A control method performed by a control apparatus that controls a cooking robot in operation, the control method comprising:
acquiring multiple recipe programs each prepared for a dish to be finished by the cooking robot going through multiple cooking processes;
executing, in a case where there is prepared a target that falls within an acceptable range for a target stipulated by the recipe program to be used in an operation constituting a cooking process, a program module for the target falling within the acceptable range; and
causing the cooking robot to execute the operation using the target falling within the acceptable range.
